(19) United States
(12) Patent Application Publication
(10) Pub. No.: US 2024/0280767 A1
(43) Pub. Date: Aug. 22, 2024

(54) Etched Coupling Structures for Bonded Photonic Dies

(71) Applicant: Apple Inc., Cupertino, CA (US)

(72) Inventors: Jeremy D. Witmer, San Jose, CA (US); Jeffrey T. Hill, Los Altos, CA (US); Yipin Wu, Cupertino, CA (US); Zhechao Wang, San Jose, CA (US)

(21) Appl. No.: 18/440,193

(22) Filed: Feb. 13, 2024

Related U.S. Application Data
(60) Provisional application No. 63/446,630, filed on Feb. 17, 2023.

(51) Int. Cl. G02B 6/42

(52) U.S. Cl. CPC G02B 6/423

(57) ABSTRACT

An integrated photonic system including multiple photonic dies that are laterally aligned using contact between pairs of vertical surfaces. The vertical surfaces can be manufactured by defining, via photolithography processes for example, the shape of the vertical surfaces. Thereafter, the vertical surfaces can be aligned and engaged, thereby optically and mechanically intercoupling the multiple photonic dies.

### CROSS-REFERENCE TO RELATED APPLICATION

This application is a nonprovisional and claims the benefit under 35 U.S.C. 119(e) of U.S. Provisional Patent Application No. 63/446,630, filed Feb. 17, 2023, the contents of which are incorporated herein by reference as if fully disclosed herein.

### TECHNICAL FIELD

Embodiments described herein relate to photonic dies and, in particular, to systems and methods providing accurate and precise alignment when connecting multiple photonic dies.

### BACKGROUND

Integrated photonic systems may include optical components that are distributed across multiple photonic dies. These photonic dies may be coupled to each other in a manner that allows light to be transmitted from one die to another. For example, in some instances a first photonic die may be a laser die that acts as a light source to generate light for use by an integrated photonic system, while a second photonic die might have optical components for routing, modifying, and/or otherwise manipulating light generated by the first photonic die. In order to allow for light transmission between the first and second photonic dies, it may be desirable to precisely align a waveguide of the first photonic die with a corresponding waveguide of the second photonic die.

When two photonic dies are coupled (e.g., bonded via a “flip-chip” process), it may be difficult to precisely align the photonic dies, which may result in misalignments between the waveguides. These misalignments may reduce the optical coupling between waveguides of the photonic dies, and thus is desirable to provide for precise mechanical alignment between photonic dies.

### SUMMARY

Embodiments described herein reference systems and methods for effective precise and accurate lateral alignment between photonic dies of an integrated photonic system. The integrated photonic system may include multiple photonic dies that are laterally aligned using contact between pairs of vertical surfaces. The vertical surfaces can be manufactured by defining, via photolithography processes for example, the shape of the vertical surfaces. Thereafter, the vertical surfaces can be aligned and engaged, thereby optically and mechanically intercoupling the multiple photonic dies.

Some embodiments are directed to an integrated photonic system that includes a first photonic die and a second photonic die defining a cavity extending at least partially therethrough. The first photonic die extends at least partially into the cavity and is bonded to the second photonic die along a vertical direction, and one or more vertical surfaces of first photonic die contact one or more vertical surfaces of the second photonic die to form multiple noncontiguous contact points between the first photonic die and the second photonic die, thereby laterally aligning the first photonic die and the second photonic die. In some of these variations, a portion of a first side of the first photonic die is shaped to define a first cavity, a portion of a first side of the second photonic die is shaped to define a first protrusion, and the first photonic die is positioned such that the first protrusion is positioned at least partially inside the first cavity to contact the first side of the second photonic die.

In some of these variations, the first protrusion has a curved cross-sectional shape, and the first cavity has a rectangular cross-sectional shape. In other variations, the first protrusion has a curved cross-sectional shape, and the first cavity has a triangular cross-sectional shape. In still other variations, the first protrusion has a curved cross-sectional shape, and the first cavity has a curved cross-sectional shape. Additionally or alternatively, an additional portion of the first side of the photonic die is shaped to define a second cavity, an additional portion of the first side of the second photonic die is shaped to define a second protrusion, and the first photonic die is positioned such that the second protrusion is positioned at least partially inside the second cavity to contact the first side of the second photonic die. In some of these variations, the second protrusion contacts the first side of the second photonic die at two non-contiguous points of contact.

In other variations, a portion of a first side of the first photonic die is shaped to define a first protrusion, a portion of a first side of the second photonic die is shaped to define a first cavity, and the first photonic die is positioned such that the first protrusion is positioned at least partially inside the first cavity to contact the first side of the first photonic die. In some of these variations, an additional portion of the first side of the photonic die is shaped to define a second cavity, an additional portion of the first side of the second photonic die is shaped to define a second protrusion, and the first photonic die is positioned such that the second protrusion is positioned at least partially inside the second cavity to contact the first side of the second photonic die. In some of these variations, the first protrusion has a curved cross-sectional shape, and the first cavity has a rectangular cross-sectional shape. In other variations, the first protrusion has a curved cross-sectional shape, and the first cavity has a triangular cross-sectional shape. In still other variations, the first protrusion has a curved cross-sectional shape, and the first cavity has a curved cross-sectional shape.

Other embodiments are directed to an integrated photonic system that includes a first photonic die a second photonic die defining a cavity extending at least partially therethrough, such that the first photonic die extends at least partially into the cavity and is bonded to the second photonic die along a vertical direction, and a first pair of vertical engagement surfaces provides at least one noncontiguous contact point between the first photonic die and the second photonic die. The first pair of vertical engagement surfaces are formed in a pair of adjacent sides of the first photonic die and the second photonic die, a first side of the pair of adjacent sides is shaped to define a first protrusion, a second side of the pair of adjacent sides is shaped to define a first cavity, and the first protrusion extends at least partially into the first cavity to contact the second side at one or more noncontiguous contact points. In some of these variations, a surface of the first cavity forms a facet for a first set of waveguides, and a surface of the first protrusion forms a facet for a second set of waveguides. In some of these variations, the first protrusion has a rectangular cross-sectional shape, and the first cavity has a rectangular cross-sectional shape. Additionally or alternatively, the first protrusion contacts the second side of a plurality of noncontiguous contact points. In some variations, the first side of the pair of adjacent sides is shaped to define a second protrusion, the second side of the pair of adjacent sides is shaped to define a second cavity, and the second protrusion extends at least partially into the second cavity to contact the second side at one or more additional noncontiguous contact points.

Still other embodiments are directed to an integrated photonic system that includes a first photonic die a second photonic die defining a cavity extending at least partially therethrough, such that a wedge-shaped portion of the first photonic die extends at least partially into the cavity and is bonded to the second photonic die along a vertical direction. The wedge-shaped portion of the first photonic die comprises a first side and a second side opposite the first side, the first side of the wedge-shaped portion acts a facet for one or more waveguides of the first photonic die and the second side of the wedge-shaped portion acts a facet for one or more waveguides of the first photonic die. A first side of the second photonic die is shaped to define a first set of protrusions contacting the first side of the wedge-shaped portion, and a second side of the second photonic die is shaped to define a second set of protrusions contacting the second side of the wedge-shaped portion. In some variations, each of the first set of protrusions acts a facet for one or more waveguides of the second photonic die. In some of these variations, each of the second set of protrusions acts a facet for one or more waveguides of the second photonic die. Additionally or alternatively, the first side of the second photonic die is shaped to define an additional protrusion that acts as a facet for one or more waveguides of the second photonic die.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIGS. 1A and 1B depict partial top and cross-sectional views of an integrated photonic system that includes two photonic dies that are bonded in a flip-chip arrangement.

FIG. 2A shows a side view of an arrangement by which two photonic dies may be bonded to each other. FIG. 2B shows a top view of a portion of the arrangement of FIG. 2A.

FIGS. 3A and 3B show partial side and top views, respectively, of a variation of an integrated photonic system that includes laterally aligned photonic dies, such as described herein.

FIGS. 4A-4E show side views of variations of integrated photonic systems configured to promote relative lateral motion between photonic dies during bonding.

FIGS. 5A-5H show partial top views of variations of integrated photonic systems that include pairs of vertical engagement surfaces, such as described herein.

FIG. 6A shows a partial top view of a variation of an integrated photonic system that includes a standoff structure that acts as a vertical engagement surface, such as described herein.

FIG. 6B shows a partial cross-sectional side view of a portion of the integrated photonic system of FIG. 6A, taken along line 6B-6B.

FIG. 7A shows a partial top view of another variation of an integrated photonic system that includes a standoff structure that acts as a vertical engagement surface, such as described herein. FIG. 7B shows a partial cross-sectional side view of a portion of the integrated photonic system of FIG. 7A, taken along line 7B-7B.

FIGS. 8A-8F show partial top views of variations of integrated photonic systems that include projections with waveguide facets, such as described herein.

FIGS. 9A-9C show side views of additional integrated photonic systems that may utilize vertical engagement surfaces, such as described herein.

FIG. 10 shows a partial top view of an integrated photonic systems that includes a set of projections with waveguide facets, such as described herein.

FIGS. 11A and 11B show partial top views of variations of integrated photonic systems that provide alignment relative to waveguides positioned on opposite sides of a photonic die.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to embodiments of integrated photonic systems having multiple photonic dies, and methods of assembling these integrated photonic systems. Specifically, embodiments of the integrated photonic systems utilize lateral contact between adjacent vertical surfaces of two photonic dies to provide mechanical alignment between the photonic dies.

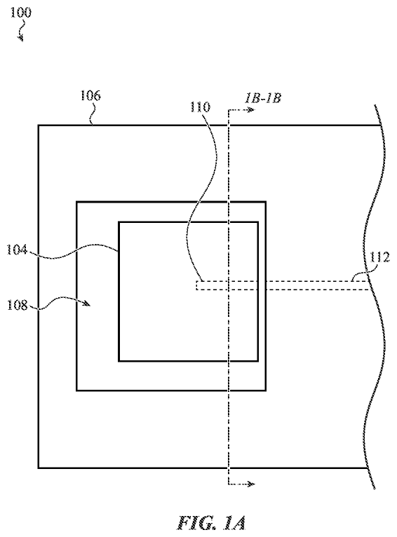

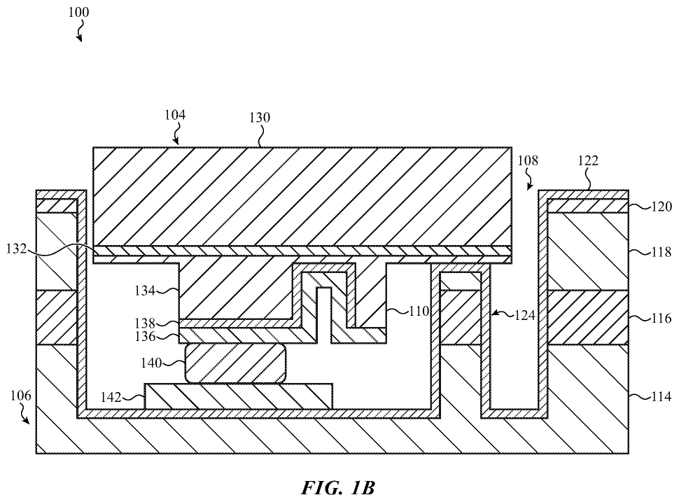

These foregoing and other embodiments are discussed below with reference to FIGS. 1A-11B. However, those skilled in the art will readily appreciate that the detailed description given herein with respect to these figures is for explanation only and should not be construed as limiting.

When two photonic dies are coupled in an integrated photonic system, precise alignment between the photonic dies may be important to the efficient operation of the photonic integrated system. When the two photonic dies are bonded in a flip-chip arrangement, precise mechanical alignment may be difficult to achieve in one or more directions. For example, FIGS. 1A and 1B show top and cross-sectional side views (taken along line 1B-1B), respectively, of an integrated photonic system 100 that includes a first photonic die 104 and a second photonic die 106, where the first photonic die 104 is bonded to the second photonic die 106 in a flip-chip arrangement. Specifically, the second photonic die 106 defines a cavity 108 extending at least partially therethrough, and the first photonic die 104 may be flipped or otherwise positioned such that the first photonic die 104 extends at least partially into the cavity 108 defined in the second photonic die 106.

With a portion of the first photonic die 104 positioned in the cavity 108, the first photonic die 104 may be bonded to the second photonic die 106 to connect the dies to each other.

It may be desirable to provide for a particular relative orientation between the first photonic die 104 and the second photonic die 106, such as to provide for precise relative placement and alignment between components of these dies. In the example of the integrated photonic system 100 shown in FIGS. 1A and 1B, the first photonic die 104 includes a waveguide (referred to herein as “first waveguide 110”) and the second photonic die 106 includes a waveguide (referred to herein as “second waveguide 112”). When the first photonic die 104 is bonded to the second photonic die 106, the first waveguide 110 and second waveguide 112 may be positioned relative to each other to allow for light to couple between the waveguides.

For example, the first photonic die 104 may be configured as a laser die that is operable to generate light, while the second photonic die 106 may be a photonic circuit die configured to receive light generated by the first photonic die 104. The second photonic die 106 may include one or more waveguides (such as the second waveguide 112) and other optical components for routing, modifying, and/or otherwise manipulating light generated by the first photonic die 104. In some examples, the second photonic die 106 may include a substrate 114, a first cladding layer 116 supported by the substrate 114, and a waveguide layer 118 positioned on the first cladding layer 116. The waveguide layer 118 may be patterned or otherwise formed to define the second waveguide 112. In some instances, one or more additional surfaces of the waveguide layer 118 may be covered with a second cladding layer 120, which may help to provide optical confinement to light traveling through optical components (such as the second waveguide 112) formed in the waveguide layer 118. These layers may be formed from any suitable materials depending on the target wavelength or wavelengths of light that will be carried by the waveguide layer 118. For example, in some variations, the second photonic die 106 is configured to carry infrared light that may be generated by the first photonic die 104. In some of these variations, the waveguide layer 118 is formed from silicon, silicon nitride, silica, or the like, the first and second cladding layers 116, 120 are formed from one or more dielectric materials such as silicon dioxide, and the substrate 114 is formed from silicon. It should be appreciated that the first and/or second photonic dies 104, 106 may include an anti-reflective coating covering one or more surfaces thereof. For example, the second photonic die 106 is shown in FIG. 1B as having an anti-reflective coating 122.

The first photonic die 104 includes an epitaxial structure 130 that includes various epitaxially-grown layers (such as quantum wells 132), which may be formed from one or more semiconductor materials (e.g., III-V semiconductor materials or the like) that may form one or more laser diodes in the first photonic die 104. The first waveguide 110 may form a laser waveguide that confines and directs light generated by the first photonic die 104. To power the laser, the first photonic die 104 may include a ridge 134 that may facilitate an electrical connection between the first photonic die 104 and the second photonic die 106. Specifically, the ridge 134 may support an electrical contact (referred to herein as “first electrical contact 136”) formed from an electrically conductive material (e.g., gold or the like). The first electrical contact 136 may be electrically coupled to a top surface of the first waveguide 110 to allow current to be supplied to the first waveguide 110 for generating light. The first photonic die 104 may further include an insulating layer 138 between the electrical contact 136 and other portions of the epitaxial structure 130 (such as a lateral side of the first waveguide 110) to electrically insulate the first electrical contact 136 from other portions of the epitaxial structure 130. It should be appreciated that while a single waveguide (i.e., first waveguide 110) is shown in FIGS. 1A and 1B, the first photonic die 104 may include multiple waveguides, each of which forms part of a respective laser diode. These multiple laser diodes may be controlled together or separately to generate light.

The first electrical contact 136 may be electrically connected to a corresponding electrical contact (referred to herein as “second electrical contact 142”) that is formed on a surface of the cavity 108. For example, a solder bump 140 may electrically connect the first electrical contact 136 to the second electrical contact 142, and may further bond the first photonic die 104 to the second photonic die 106. This electrical connection may allow for current to be passed from the second photonic die 106 (via second electrical contact 142) to the first photonic die 104 (via the first electrical contact 136), to help power the first photonic die 104.

Flip-chip bonding of two photonic dies can introduce lateral and/or vertical misalignment of certain circuit elements if the dies are not properly positioned relative to each other. Accordingly, it may be desirable to introduce mechanical structures configured to provide mechanical alignment between two photonic dies. In some instances, a standoff structure (e.g., a post) may assist with vertical alignment of the dies. For example, in the variation shown in FIG. 1B, the second photonic die 106 may include one or more posts (such as post 124) positioned in the cavity 108. For example, portions of the layers of the second photonic die 106 may be removed (e.g., via etching) to define the cavity 108, and this material may be selectively removed to leave the one or more posts. Additionally or alternatively, one or more posts may be separately formed and placed into the cavity 108. As the first photonic die 104 is flipped and inserted into the cavity 108, the one or more posts (such as post 124) may limit how far the first photonic die 104 can extend into the cavity 108, and thereby set the vertical positioning (e.g., the Z-axis positioning) of the first photonic die 104 in the cavity 108.

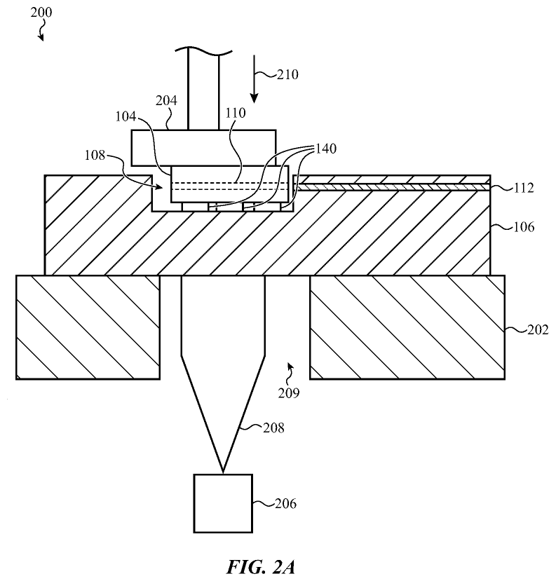

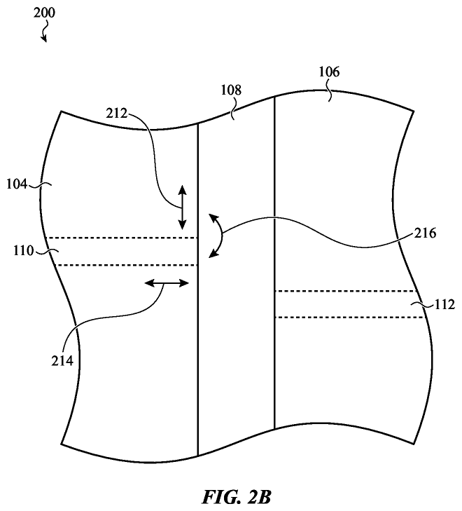

As shown in FIG. 1B, the post 124 only provides for alignment in the vertical direction (within manufacturing tolerances of the posts themselves), but not in lateral directions (e.g., the X-axis positioning and Y-axis positioning). FIGS. 2A and 2B illustrate how flip-chip bonding on the first and second photonic dies 104, 106 of the integrated photonic system 100 may result in lateral misalignments between the dies. Specifically, FIG. 2A shows an example of a simplified manufacturing arrangement 200 for bonding the first photonic die 104 to the second photonic die 106 (shown in cross-section). Specifically, the manufacturing arrangement may include a mounting structure 202 (shown in cross-section) configured to releasably hold (e.g., via vacuum or the like) the second photonic die 106, and a bond head 204 configured to releasably hold (e.g., via vacuum or the like) the first photonic die 104. The bond head 204 is moveable relative to the mounting structure 202 to move the first photonic die 104 relative to the second photonic die 106. The bond head 204 may be releasably coupled to a bottom side of the first photonic die 104 and may insert the first photonic die 104 into the cavity 108 of the second photonic die 106 along a vertical direction 210, such that a top side of the first photonic die 104 faces a top side of the second photonic die 106 (since the first photonic die 104 is “flipped” relative to the second photonic die 106). Standoff structures (not shown in FIGS. 2A and 2B) may limit how far the first photonic die 104 is advanced along the vertical direction, such as described herein, which may help to set the vertical alignment between the dies. A light source 206 may direct light 208 through the mounting structure 202 (e.g., through a cavity 209 defined through the mounting structure) to heat the solder bumps 140 (multiple of which are shown in FIG. 2A), which may melt the solder and thereby bond the first photonic die 104 to the second photonic die 106.

As the first photonic die 104 is positioned within the cavity 108, there may be lateral misalignments between the first photonic die 104 and the second photonic die 106. FIG. 2B shows a top view of a portion of manufacturing arrangement 200 that highlights the lateral misalignments that may occur between first waveguide 110 and the second waveguide 112. As shown there, misalignments may occur as a displacement along a first lateral direction 212 (e.g., a first direction perpendicular to the vertical direction 210), a displacement along a second lateral direction 214 (e.g., a second direction perpendicular to both the first lateral direction 212 and the vertical direction 210), a rotation 216 around the vertical direction 210, or a combination thereof. Any of these translational or rotational misalignments may reduce the coupling efficiency of light passing between the first and second waveguides 110, 112.

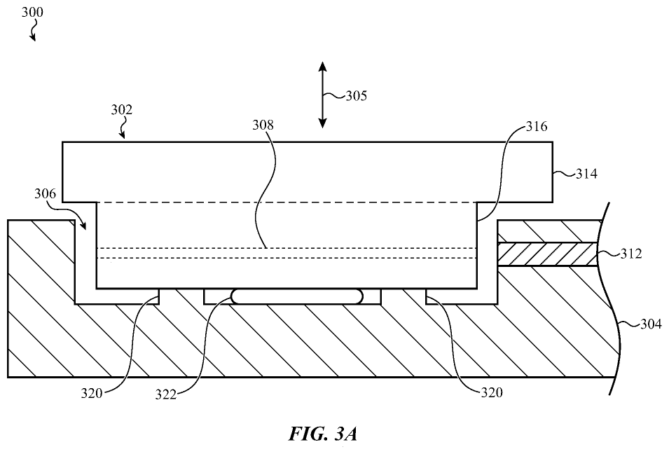

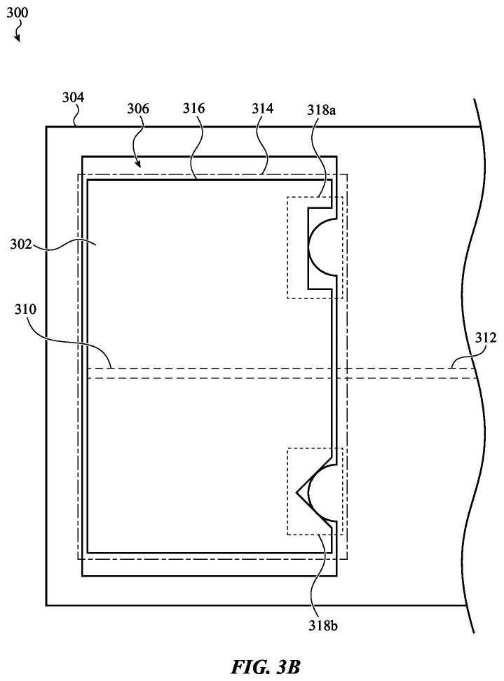

Accordingly, embodiments of the integrated photonic systems described herein are configured to improve the lateral mechanical alignment between two photonic dies. Specifically, the integrated photonic systems described herein utilize lateral contact between adjacent vertical surfaces of the photonic dies to laterally align these dies. For example, FIGS. 3A and 3B show side and top views, respectively, of an example of an integrated photonic system 300 as described herein. As shown, the integrated photonic system includes a first photonic die 302 and a second photonic die 304 (shown in cross-section in FIG. 3A). The second photonic die 304 defines a cavity 306 extending at least partially through the second photonic die 304 along a vertical direction 305, and the first photonic die 302 is positioned such that a portion of the first photonic die 302 extends into the cavity 306 along the vertical direction 305.

The first photonic die 302 and the second photonic die 304 may be bonded together (e.g., via solder 322) in a flip chip arrangement, such as described herein with respect to the integrated photonic system 100 of FIGS. 1A and 1B. For example, the first photonic die 302 may be configured as a laser die that is operable to generate light (e.g., via an epitaxial structure with a plurality of epitaxial layers, such as quantum wells 308), while the second photonic die 304 may be a photonic circuit die configured to receive light generated by the first photonic die 302. While certain details of the integrated photonic system 300 (such as the various layers making up the photonic dies) are not depicted in FIGS. 3A and 3B, it should be appreciated that the first photonic die 302 and second photonic die 304 may be configured in any manner as described herein with respect to the first photonic die 104 and the second photonic die 106 of the integrated photonic system 100 of FIGS. 1A and 1B.

It may be desirable to provide precise mechanical alignment between the first photonic die 302 and the second photonic die 304 in multiple directions, which may help achieve relative alignment between certain components of the photonic dies. For example, it may be desirable to achieve a particular alignment between a waveguide of the first photonic die 302 (referred to herein as “first waveguide 310”) and a corresponding waveguide of the second photonic die 304 (referred to herein as “second waveguide 312”), to facilitate transferring light between the first waveguide 310 and the second waveguide 312.

To facilitate lateral alignment between the first photonic die 302 and the second photonic die 304, the integrated photonic system 300 may utilize lateral contact between vertical surfaces of the first photonic die 302 and the second photonic die 304. Specifically, the first photonic die 302 includes one or more vertical surfaces (i.e., surfaces that are parallel to the vertical direction 305 along which the first photonic die 302 extends into the cavity 306) that contact one or more corresponding vertical surfaces of the second photonic die 304. As used herein, a “pair of vertical engagement surfaces” relate to two vertical surfaces, one from a first photonic die and the other from a second photonic die, that contact each other at one or more contact points. Each vertical engagement surface is formed from a portion of a side of a corresponding photonic die. In some instances, a side of one photonic die may be shaped to protrude outward toward an adjacent side of another photonic die, thereby defining a protrusion. Additionally or alternatively, a side of one photonic die may be shaped to extend inwardly away from an adjacent side of another photonic die, thereby defining a cavity. A vertical surface (or surfaces) of a photonic die that defines a protrusion or a cavity may act as a vertical engagement surface to contact another photonic die.

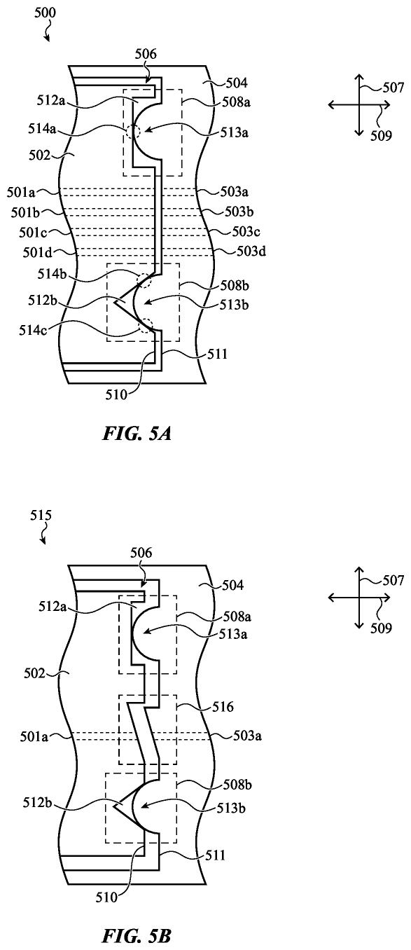

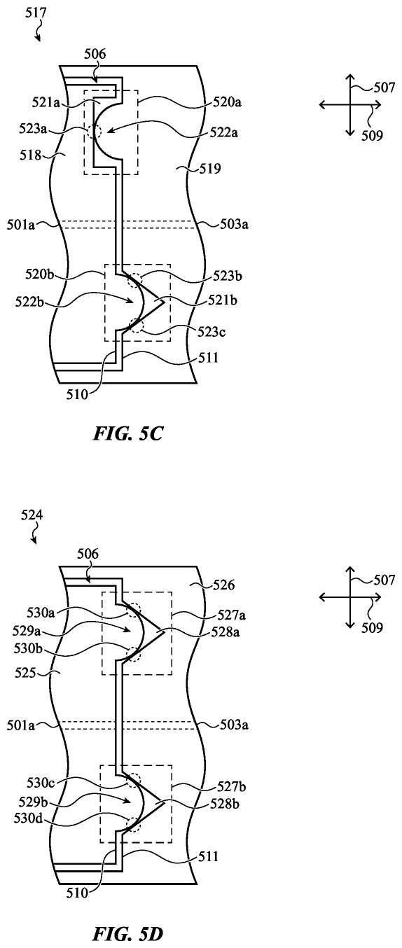

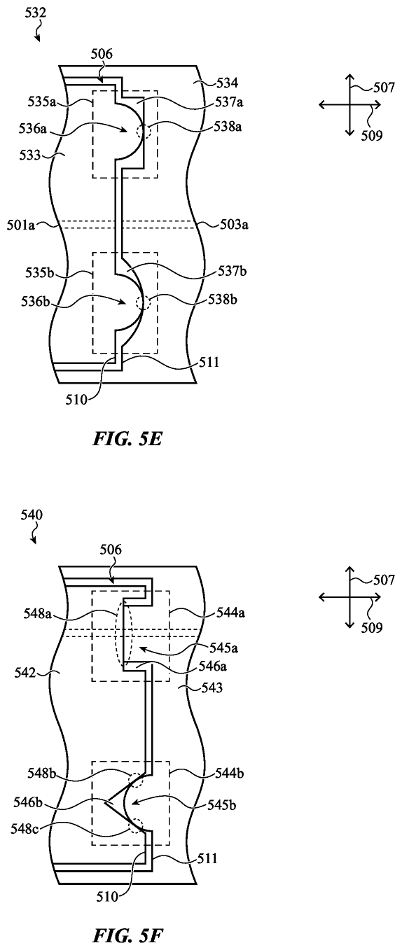

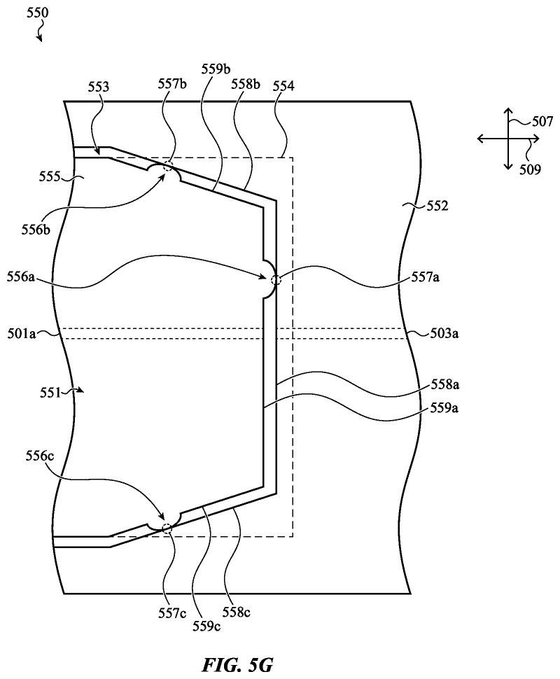

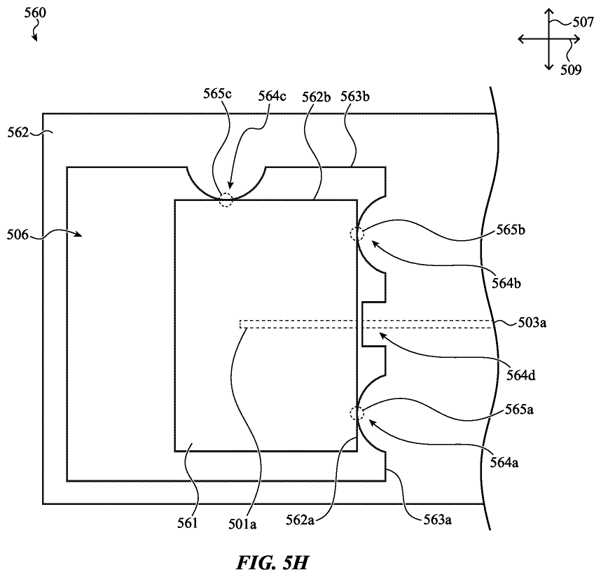

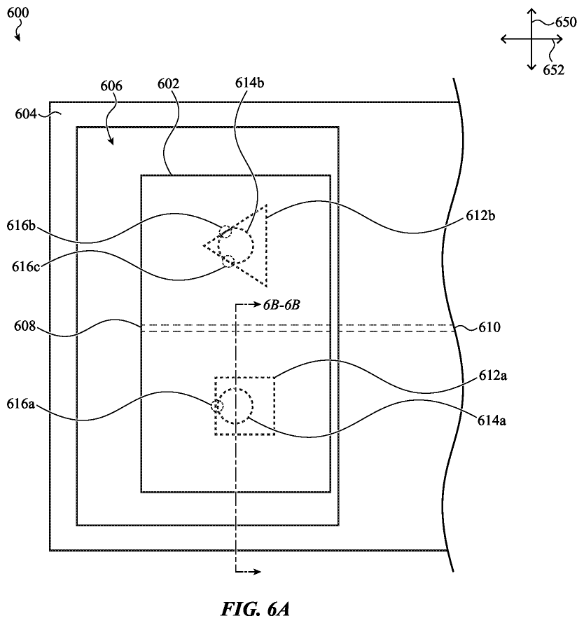

For example, in the example shown in FIG. 3B, the integrated photonic system includes a first pair 318a and a second pair 318b of vertical engagement surfaces. For each of these pairs 318a, 318b, a vertical surface of the first photonic die 302 contacts a corresponding vertical surface of the second photonic die 304 at one or more contact points. Depending on the number and location of these contact points, the pairs of vertical engagement surfaces can provide rotational and/or translational lateral alignment (e.g., translation alignment in the first lateral direction 212, translational alignment in the second lateral direction 214, and/or rotational alignment in a direction 216 around the vertical direction, as described herein with respect to FIG. 2B). Examples of pairs of vertical engagement surfaces are described herein with respect to FIGS. 5A-8F and 10-11B, and it should be appreciated that the integrated photonic system may include any combination of pairs of vertical engagement surfaces described with respect to these figures.

Some or all of the vertical engagement surfaces used to facilitate this lateral alignment may be defined by selectively removing material (e.g., via etching) from a portion of its respective photonic die. For example, vertical engagement surfaces may be formed in the second photonic die 304 during creation the cavity 306. For example, as discussed in more detail herein, the outer periphery of the cavity 306 may be shaped to define one or more vertical engagement surfaces. In another example, a portion of the first photonic die 302 may be selectively removed (e.g., via etching) to define the shape of a portion of the first photonic die 302 that is positioned at least partially within the cavity 306.

For example, in the variation shown in FIGS. 3A and 3B, the first photonic die 302 may be etched to define a base region 314 (shown in phantom in FIG. 3B) and an upper region 316, where the base region 314 and upper region 316 have different cross-sectional shapes. This allows the first photonic die 302 to be singulated from a wafer using conventional techniques (e.g., cleaving, dicing, etc.) that would otherwise limit the options for the shape of the first photonic die 302. Specifically, the shape of the upper region 316 of the first photonic die 302 may be lithographically defined by etching, allowing for a greater variety of shapes of the upper region 316 as compared to the base region 314.

Accordingly, the upper region 316 may be at least partially inserted into the cavity 306 during flip-chip bonding. The upper region 316 may be sized to fit at least partially into the cavity 306, but the base region 314 need not be. For example, in some variations (as illustrated in FIGS. 3A and 3B), the first photonic die 302 may be configured such that a portion of the base region 314 extends laterally beyond an outer perimeter of the cavity 306 when the first photonic die 302 is bonded to the second photonic die 304. In other words, at least a portion of the base region 314 may overlap with the second photonic die 304 outside of the cavity 306. For example, in the example shown in FIG. 3B, the base region 314 may extend over the first and second pairs 318a, 318b of vertical engagement surfaces, and over a portion of the second waveguide 312.

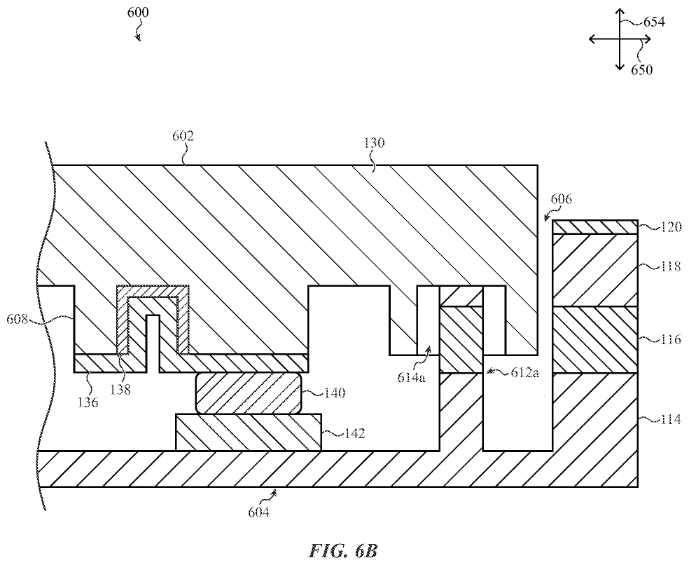

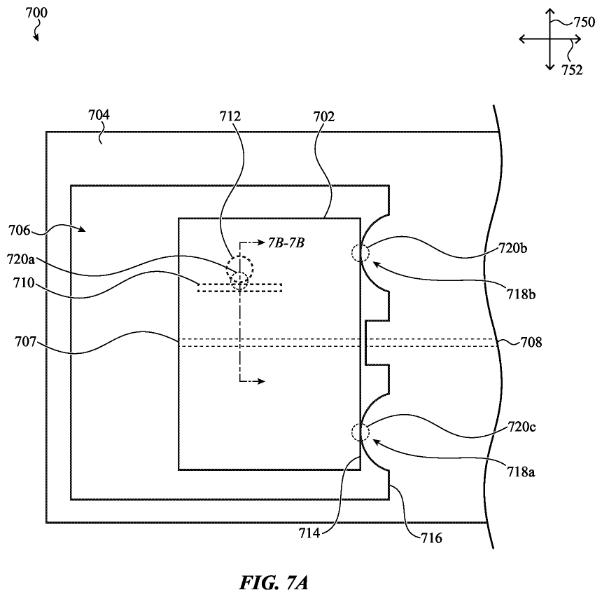

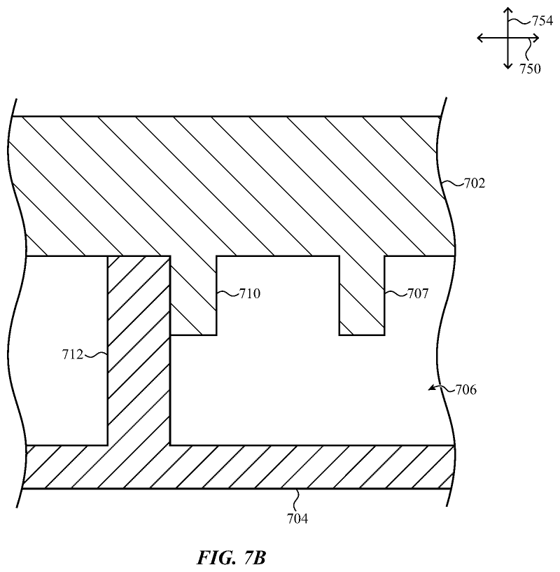

In some instances, the second photonic die 304 may include one or more standoff structures (e.g., posts 320) positioned in the cavity 306 that may facilitate vertical alignment of the first photonic die 302 within the cavity 306, such as discussed herein with respect to the post 124 of the integrated photonic system 100 of FIGS. 1A and 1B. In some variations, such as discussed with respect to FIGS. 6A-7B, one or more of the posts 320 may also form a vertical engagement surface.

Because the lateral alignment between the first and second photonic dies 302, 304 utilizes physical contact between vertical surfaces of these dies, the bonding process may utilize relative lateral movement between the first and second photonic dies 302, 304 to place these dies into lateral physical contact. This lateral movement may occur after the first photonic die 302 has been translated vertically to extend at least partially into the cavity 306, or may occur simultaneously with this vertical movement. Additionally, the lateral movement may occur using any suitable technique(s). For example, in instances where a mounting structure (e.g., mounting structure 202) and a bond head (e.g., bond head 204) are configured to move the first photonic die 302 vertically relative to each other, these components may also be used to create lateral relative movement to push pairs of vertical engagement surfaces into physical contact.

Additionally or alternatively, the first photonic die 302 and/or the second photonic die 304 may be selectively heated to urge vertical engagement surfaces into physical contact. In these instances, regions of the dies that are heated may thermally expand, and this thermal expansion may push a vertical surface of one of the photonic dies into contact with a corresponding vertical surface of the other photonic die. For example, thermal expansion of the second photonic die 304 during heating may cause a peripheral side of the cavity 306 to more toward a corresponding surface of the first photonic die 302.

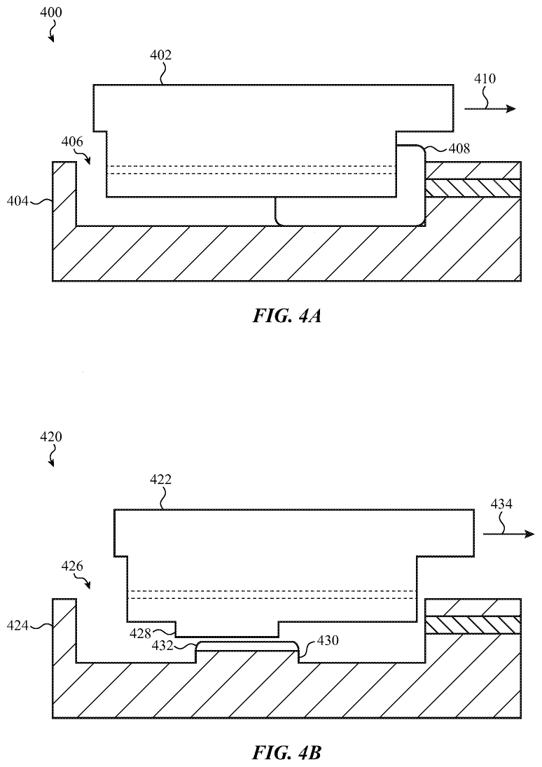

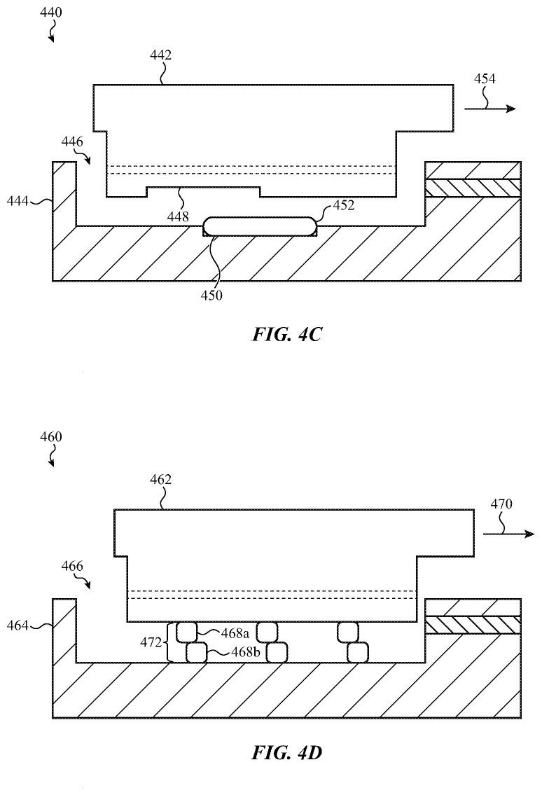

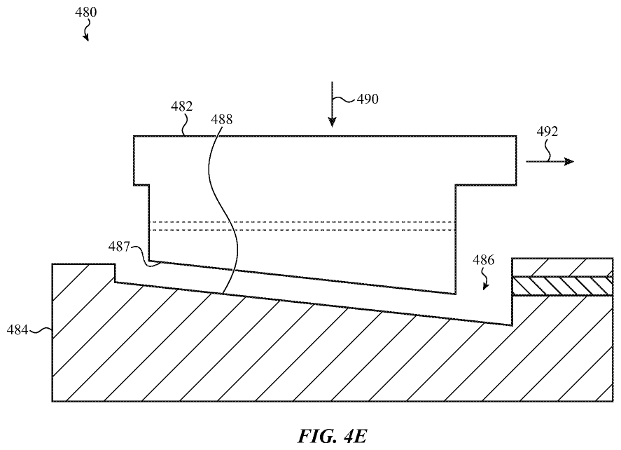

FIGS. 4A-4E show additional techniques to facilitate lateral movement between photonic dies of an integrated photonic system. FIG. 4A shows a side view of a variation of an integrated photonic system 400 in which an adhesive 408 is used to help couple a first photonic die 402 to a second photonic die 404 (shown in cross-section). The first and second photonic dies 402, 404 may be configured in any manner as described with respect to the first and second photonic dies 302, 304 of FIGS. 3A and 3B. When a portion of the first photonic die 402 is positioned at least partially inside of a cavity 406 defined at least partially through the second photonic die 404, the adhesive 408 may be introduced between the first and second photonic dies 402, 404. As the adhesive 408 is introduced between the photonic dies 402, 404, surface tension may result in a lateral shift of the first photonic die 402 relative to the second photonic die 404 along a lateral direction 410. This lateral shift may be sufficient (alone or in combination with other lateral forces applied to the first photonic die 402) to pull one or more vertical engagement surfaces of the first photonic die 402 into contact with one or more corresponding vertical engagement surfaces of the second photonic die 404.

In some instances, a pair of photonic dies of an integrated photonic system may be defined with surface features to promote lateral movement caused by surface tension in an adhesive between the photonic dies. For example, FIG. 4B shows a side view of another variation of an integrated photonic system 420 in which an adhesive 432 is used to help couple a first photonic die 422 to a second photonic die 424 (shown in cross-section). The first and second photonic dies 422, 424 may be configured the same as the first and second photonic dies 402, 404 of FIG. 4A, except that the first photonic die 422 defines a platform (referred to herein as “first platform 428”) and the second photonic die 424 defines a platform (referred to herein as “second platform 430”). In these instances, an amount of adhesive 432 may be placed on one of the platforms (e.g., on the second platform 430 as depicted in FIG. 4B). The first photonic die 422 may be at least partially inserted vertically into a cavity 426 defined in the second photonic die 424 until the adhesive 432 contacts both the first platform 428 and the second platform 430. If the first photonic die 422 is inserted into the cavity 426 with the first and second platforms 428, 430 out of alignment, surface tension in the adhesive 432 will provide a lateral force in one or more directions between the first and second photonic dies 422, 424 in an attempt to bring the first and second platforms 428, 430 into alignment. This lateral force may promote lateral movement of the first photonic die 402 relative to the second photonic die 404 along a lateral direction 434. This lateral force may be sufficient (alone or in combination with other lateral forces applied to the first photonic die 422) to pull one or more vertical engagement surfaces of the first photonic die 422 into contact with one or more corresponding vertical engagement surfaces of the second photonic die 424. While shown in FIG. 4B as having a single pair of platforms (i.e., first platform 428 and second platform 430), the integrated photonic system 420 may include multiple pairs of platforms, each with a corresponding amount of adhesive positioned therebetween, to facilitate bonding and lateral movement between the first and second photonic dies 422, 424.

FIG. 4C shows a side view of another variation of an integrated photonic system 440 in which an adhesive 452 is used to help couple a first photonic die 442 to a second photonic die 444 (shown in cross-section). The first and second photonic dies 442, 444 may be configured the same as the first and second photonic dies 402, 404 of FIG. 4A, except that the first photonic die 442 defines a channel (referred to herein as “first channel 448”) in a surface thereof and the second photonic die 444 defines a channel (referred to herein as “second channel 450”) in a surface thereof (e.g., a surface of a cavity 446 defined to extend at least partially through the second photonic die 444)). In these instances, an amount of adhesive 452 may be placed in one of the channels (e.g., in the second channel 450 as depicted in FIG. 4C). The first photonic die 442 may be inserted vertically at least partially into the cavity 446 until the adhesive 452 contacts both the first channel 448 and the second channel 450. If the first photonic die 442 is inserted into the cavity 446 with the first and second channels 448, 450 out of alignment, surface tension in the adhesive 452 will provide a lateral force in one or more directions between the first and second photonic dies 442, 444 in an attempt to bring the first and second channels 448, 450 into alignment. This lateral force (alone or in combination with other lateral forces applied to the first photonic die 422) may cause lateral movement of the first photonic die relative to the second photonic die 404 along a lateral direction 454. This lateral force may be sufficient to pull one or more vertical engagement surfaces of the first photonic die 442 into contact with one or more corresponding vertical engagement surfaces of the second photonic die 444. While shown in FIG. 4C as having a single pair of channels (i.e., first channel 448 and second channel 450), the integrated photonic system 440 may define multiple pairs of channels, each with an amount of adhesive positioned therebetween, to facilitate bonding and lateral movement between the first and second photonic dies 442, 444.

Additionally or alternatively, misaligned bonding regions may be used to facilitate lateral movement between photonic dies of an integrated photonic system. For example, FIG. 4D shows a side view of a variation of an integrated photonic system 460 in which one or more sets of misaligned bond regions 472 is used to help couple a first photonic die 462 to a second photonic die 464 (shown in cross-section). The first and second photonic dies 462, 464 may be configured in any manner as described with respect to the first and second photonic dies 302, 304 of FIGS. 3A and 3B. The first photonic die 462 includes one or more solder pads (referred to herein as “first solder pads 468a”) connected to a surface thereof, and the second photonic die 464 includes one or more solder pads (referred to herein as “second solder pad 468b”).

When a portion of the first photonic die 462 is positioned to extend at least partially inside of a cavity 466 defined in the second photonic die 464, each first solder pad 468a may be placed in contact with a second solder pad 468b such that the first and second solder pads 468a, 468b are misaligned. Accordingly, each pair of first and second solder pads 468a, 468b form a misaligned bond region 472. When the misaligned bond regions 472 are heated to melt the solder, such as described with respect to FIGS. 2A and 2B, the surface tension of the solder tries to pull each first solder pad 468a into alignment with its corresponding second solder pad 468b. This may result in a lateral shift of the first photonic die 462 relative to the second photonic die 464 along a lateral direction 470. This lateral shift may be sufficient (alone or in combination with other lateral forces applied to the first photonic die 462) to pull one or more vertical engagement surfaces of the first photonic die 462 into contact with one or more corresponding vertical engagement surfaces of the second photonic die 464.

In some variations, an integrated photonic system may be configured such that downward motion of one photonic die is converted to lateral movement. For example, FIG. 4E shows a side view of a variation of an integrated photonic system 480 in which one or more angled surfaces are used to help laterally translate a first photonic die 482 relative to a second photonic die 484 (shown in cross-section). The first and second photonic dies 482, 484 may be configured in any manner as described with respect to the first and second photonic dies 302, 304 of FIGS. 3A and 3B, except that at least one of the first and second photonic dies 482, 484 each has an angled surface.

When a portion of the first photonic die 482 is inserted at least partially inside of a cavity 486 defined to extend at least partially through the second photonic die 484, movement of the first photonic die 482 in a vertical direction 490 causes an angled surface of the first photonic die 482 (referred to herein as “first angled surface 487”) to contact an angled surface of the second photonic die 484 (referred to herein as the “second angled surface 488”). When the first angled surface 487 is in contact with the second angled surface 488, further movement of the first photonic die 482 in the direction 490 will cause the first photonic die 482 to translate laterally relative to the second photonic die 484. This lateral movement may push one or more vertical engagement surfaces of the first photonic die 482 into contact with one or more corresponding vertical engagement surfaces of the second photonic die 484. It should be appreciated that multiple techniques (such as any combination of those described herein with respect to FIGS. 4A-4E) may be used to laterally translate two photonic dies relative to each other. Additionally, any portions of a pair of photonic dies that slide relative to each other may be coated with a material configured to reduce friction between the pair of photonic dies.

As discussed with respect to FIGS. 3A and 3B, in order to provide lateral (i.e., in plane) alignment between photonic dies of an integrated photonic system, one or more vertical engagement surfaces of a first photonic die contacts one or more corresponding vertical engagement surfaces of a second photonic die at multiple noncontiguous contact points (e.g., two, three, or four or more noncontiguous contact points). These contact points between vertical surfaces of the photonic dies may provide rotational and/or translational lateral alignment between the photonic dies as described herein. The photonic dies may include one or more pairs of vertical engagement surfaces configured to provide a plurality of noncontiguous contact points between vertical surfaces of two photonic dies.

FIGS. 5A-5G show variations of integrated photonic systems that include multiple pairs of vertical engagement surfaces that collectively provide multiple noncontiguous contact points between a pair of photonic dies. For example, FIG. 5A shows a partial top view of a variation of an integrated photonic system 500 that includes a first photonic die 502 and a second photonic die 504. The integrated photonic system 500 may be configured in any manner as described herein with respect to FIGS. 1A-4E. The second photonic die 504 defines a cavity 506 extending at least partially therethrough, and the first photonic die 502 may be flipped or otherwise positioned such that the first photonic die 502 extends at least partially into the cavity 506. In some instances, the portion of the first photonic die 502 shown in FIG. 5A may be an upper region of the first photonic die 502, and the first photonic die 502 may further include a base region (not shown) having a different shape as described herein.

With a portion of the first photonic die 502 positioned in the cavity 506, the first photonic die 502 may be bonded to the second photonic die 504 to connect the dies to each other. It may be desirable to provide for a particular relative orientation between the first photonic die 502 and the second photonic die 504, such as between one or more waveguides (e.g., a first set of waveguides 501a-501d) of the first photonic die 502 and a second set of waveguides (e.g., a second set of waveguides 503a-503d) of the second photonic die 504. While the first and second photonic dies 502, 504 are shown as aligning four pairs of waveguides, it should be appreciated that the dies may align any number of pairs of waveguides (e.g., one, two, three, or four or more pairs of waveguides).

To help laterally align the first and second sets of waveguides 501a-501d, 503a-503d, the integrated photonic system 500 includes a first pair of vertical engagement surfaces 508a and a second pair of vertical engagement surfaces 508b, where each pair of vertical engagement surfaces provides at least one noncontiguous contact point between the first photonic die 502 and the second photonic die 504. In the variation shown in FIG. 5A, the first and second pairs of vertical engagement surfaces 508a, 508b, are formed in a common pair of adjacent sides of the first and second photonic dies 502, 504. This pair of adjacent sides includes a first side of the first photonic die 502 (referred to herein as “first side 510”) and a first side of the second photonic die 504 (referred to herein as “second side 511”). The first side 510 faces and is adjacent to the second side 511 when the first photonic die 502 is at least partially inserted vertically into the cavity 506. In some variations, the first side 510 forms part of the outer perimeter of the first photonic die 502 (or an upper region thereof), and may define a facet for each of the first set of waveguides 501a-501d (which may allow light to enter or exit the first photonic die 502 via the first set of waveguides 501a-501d). Similarly, the second side 511 forms part of the outer perimeter of the cavity 506 and may define a facet for each of the second set of waveguides 503a-503d (which may allow light to enter or exit the second photonic die 504 via the second set of waveguides 503a-503d).

In the example shown in FIG. 5A, the first pair of vertical engagement surfaces 508a is configured to provide a single contact point (referred to herein as “first contact point 514a”) between the first side 510 and second side 511, while the second pair of vertical engagement surfaces 508b is configured to provide two noncontiguous contact points (referred to herein as “second contact point 514b” and “third contact point 514c”) between the first side 510 and the second side 511. The first, second, and third contact points 514a-514c are noncontiguous, and provide for alignment in two lateral directions (i.e., a first lateral direction 507 and a second lateral direction 509 that is perpendicular to the first lateral direction 507), as well as lateral rotational alignment (i.e., around a vertical direction perpendicular to both the first and second lateral directions 507, 509).

Specifically, for the first pair of vertical engagement surfaces 508a, a portion of the first side 510 is shaped (e.g., lithographically defined) to define a cavity (referred to herein as “first cavity 512a”), and a portion of the second side 511 is shaped (e.g., lithographically defined) to form a protrusion (referred to herein as “first protrusion 513a”). During bonding, when the first side 510 is moved toward the second side 511 along the second lateral direction 509, a vertical surface of first protrusion 513a will be positioned at least partially within the first cavity 512a to contact the first side 510 at a single point. Specifically, the vertical surface of the first protrusion 513a contacts of a portion of the first side 510 that defines the first cavity 512a. This contact between vertical surfaces of the first and second dies 502, 504 creates the first contact point 514a. The first protrusion 513a and first cavity 512a may have any suitable respective shapes that allow for a single point of contact therebetween. In the variation shown in FIG. 5A, the first cavity 512a has a rectangular cross-sectional shape while the first protrusion 513a has a curved cross-sectional shape (e.g., a semicircular shape, a semioval shape, or the like). As a result, the curve of the first protrusion 513a will contact one of the surfaces of the first cavity 512a at a single point (i.e., at the first contact point 514a).

For the second pair of vertical engagement surfaces 508b, another portion the first side 510 is shaped to define a cavity (referred to herein as “second cavity 512b”), and another portion of the second side 511 is shaped to form a protrusion (referred to herein as “second protrusion 513b”). During bonding, when the first side 510 is moved toward the second side 511 along the second lateral direction 509, a vertical surface of the second protrusion 513b will be positioned at least partially within the second cavity 512b to contact the first side 510 at two noncontiguous points. Specifically, the vertical surface of the second protrusion 513b contacts of two different portions of the first side 510 that defines the second cavity 512b. This contact between vertical surfaces of the first and second dies 502, 504 creates the second and third contact points 514b, 514c. The second protrusion 513b and second cavity 512b may have any suitable respective shapes that allow for two non-contiguous points of contact therebetween. In the variation shown in FIG. 5A, the second cavity 512b has a triangular cross-sectional shape while the second protrusion 513b has a curved cross-sectional shape (e.g., a semicircular shape, a semioval shape, or the like). As a result, the curve of the second protrusion 513b will contact two of the surfaces of the second cavity 512b (i.e., at the second and third contact points 514b, 514c).

Overall, when the first photonic die 502 is moved laterally relative to the second photonic die 504 along lateral direction 509, the second and third contact points 514b, 514c may set the lateral translational alignment between the first and second photonic dies 502, 504 in the first and second lateral directions 507, 509, while the first contact point 514a may set the lateral rotational alignment between the photonic dies. Additionally, because the same sides of these photonic dies (i.e., the first side 510 and the second side 511) are used to form both i) the first and second pairs of vertical engagement systems 508a, 508b, and ii) the facets for the first and second sets of waveguides 501a-501d, 503a-503d, this may provide for precise mechanical alignment between the first and second photonic dies 502, 504 and the first and second sets of waveguides 501a-501d, 503a-503d.

In some instances, the facets defined by the first and/or second sides 510, 511 may be configured to help reduce back reflections that may occur as light enters or leaves the photonic dies. For example, FIG. 5B shows a partial top view of a variation of an integrated photonic system 515, which may be identical to (and labeled the same as) the integrated photonic system 500 except for a region 516 encompassing a portion of each the first and second sides 510, 511. This region 516 includes a portion of the first side 510 that forms the output facet(s) for the first set of waveguides (only a first waveguide 501a thereof is depicted in FIG. 5B), and further includes a portion of the second side 511 that forms the output facet(s) for the second set of waveguides (only a first waveguide 503a is depicted in FIG. 5B). These portions of the first and second sides 510, 511 may be angled so that the first and second sets of waveguides are aligned relative to their corresponding sides (and thereby their facets) at a non-perpendicular angle. Specifically, waveguide 501a is oriented at a non-perpendicular angle relative to the first side 510, while waveguide 503a is oriented at a non-perpendicular angle relative to the second side 511. The waveguides 501a, 503a may still be parallel to each other and aligned such that light may travel between these waveguides 501a, 503a.

While the first and second pairs of vertical engagement surfaces 508a, 508b of FIGS. 5A and 5B are configured such that first and second protrusions 513a, 513b are formed in the second photonic die 504 (e.g., as part of the second surface 511), it should be appreciated that in other variations one or both of the first and second protrusions 513a, 513b may instead be formed in the first photonic die 502 (e.g., as part of the first side 510), in which case one or both of the first and second cavities 512a, 512b are defined by the second photonic die 504 (e.g., as part of the second side 511). For example, FIG. 5C shows a partial top view of one such variation of an integrated photonic system 517 that includes a first photonic die 518 and a second photonic die 519. The second photonic die 519 defines a cavity 506 extending at least partially therethrough, and the first photonic die 518 may be flipped or otherwise positioned such that the first photonic die 518 (or an upper region thereof) extends at least partially into the cavity 506.

The first and second photonic dies 518, 519 may be configured and labeled as described with respect to FIGS. 5A and 5B, except that the first and second photonic dies 518, 519 include a first pair of vertical engagement surfaces 520a and a second pair of vertical engagement surfaces 520b. These pairs of vertical engagement surfaces 520a, 520b are defined in adjacent sides of first and second photonic dies 518, 519 (respectively, a first side 510 and a second side 511 as discussed with respect to FIGS. 5A and 5B). The first pair of vertical engagement surfaces 520a includes a portion of the first side 510 shaped to define a cavity (hereinafter referred to as “first cavity 521a”) and a protrusion (hereinafter referred to as “first protrusion 522a) formed in a portion of the second side 511. The first pair of vertical engagement surfaces 520a may be configured and operate to define a single contact point (referred to herein as “first contact point 523a”).

The second pair of vertical engagement surfaces 520b includes another portion of the second side 511 shaped to define a cavity (hereinafter referred to as “second cavity 521b”) and a protrusion (hereinafter referred to as “second protrusion 522b) formed in another portion of the first side 510. The second protrusion 522b and second cavity 521b may be configured the same as the second protrusion 513b and second cavity 512b of FIGS. 5A and 5B to create two noncontiguous contact points (hereinafter referred to as “second contact point 523b” and “third contact point 523c”) between the second protrusion 522b and the second side 511. Accordingly, the first and second pairs of vertical engagement surfaces 520a, 520b provide three noncontiguous contact points between the first side 510 and the second side 511, and may provide the same mechanical alignment described with respect to FIGS. 5A and 5B.

FIG. 5D shows a partial top view of a variation of an integrated photonic system 524 that is configured to provide at least four noncontiguous contact points between vertical surfaces of a first photonic die 525 and a second photonic die 526. The integrated photonic system 524 may be configured and labeled the same as the integrated photonic systems of FIGS. 5A-5C, except that the integrated photonic system 524 includes a first pair of vertical engagement surfaces 527a and a second pair of vertical engagement surfaces 527b, each of which is configured to provide two noncontiguous contact points between adjacent sides of the first and second photonic dies 525, 526. As shown, the first photonic die 525 includes a side (first side 510) that faces an adjacent side (second side 511) of the second photonic die 526.

Each of the first and second pairs of vertical engagement surfaces 527a, 527b may be configured the same as the pair of vertical engagement surfaces 508b described with respect to FIG. 5A, though it should be appreciated that either or both of these pairs of vertical engagement surfaces 527a, 527b may instead be configured as described with respect to the pair of vertical engagement surfaces 520b of FIG. 5C. In the example shown in FIG. 5D, the first pair of vertical engagement surfaces 527a includes a first protrusion 529a formed in a portion of the first side 510, where the first protrusion 529a extends into a first cavity 528a defined by a portion the second surface 511, thereby forming a first contact point 530a and a second contact point 530b between the first and second sides 510, 511. Similarly, the second pair of vertical engagement surfaces 527b includes a second protrusion 529b formed in another portion of the first side 510, where the second protrusion 529b extends into a second cavity 528b defined by another portion of the second surface 511, thereby forming a third contact point 530c and a fourth contact point 530d between the first and second sides 510, 511. The four noncontiguous contact points may provide directional alignment in multiple lateral directions (e.g., along the first and second lateral directions 507, 509) as well as lateral rotational alignment.

FIG. 5E shows a partial top view of a variation of an integrated photonic system 532 that is configured to provide at least two noncontiguous contact points between vertical surfaces of a first photonic die 533 and a second photonic die 534. The integrated photonic system 532 may be configured and labeled the same as the integrated photonic systems of FIGS. 5A-5D, except that the integrated photonic system 532 includes a first pair of vertical engagement surfaces 535a and a second pair of vertical engagement surfaces 535b, each of which is configured to provide a single contact point between adjacent sides (i.e., first side 510 and second side 511, respectively) of the first and second photonic dies 533, 534.

The first pair of vertical engagement surfaces 535a may be configured the same as the pair of vertical engagement surfaces 508a described with respect to FIG. 5A, however in the example shown in FIG. 5E, a portion the first side 510 is shaped to form a protrusion (referred to herein as “first protrusion 536a”) instead of a portion of the second side 511. The first protrusion 536a extends into a cavity (referred to herein as “first cavity 537a”) defined in the second side 511 to create a single contact point (referred to herein as “first contact point 538a”).

Similarly, for the second pair of vertical engagement surfaces 535a, the first side 510 is shaped to form a protrusion (referred to herein as “second protrusion 536b”) and the second side 511 is shaped to define a cavity (referred to herein as “second cavity 537b”), or vice versa. The second protrusion 536b extends into the second cavity 537b to create a single contact point (referred to herein as “second contact point 538b”) between the second protrusion 536b and the second side 511. The second side 511 has a curved segment defining the second cavity 537b such that the second cavity 537b has a curved cross-sectional shape (e.g., a semicircular shape, a semioval shape, or the like. The second protrusion 536b may have any suitable shape to provide the second contact point 538b (e.g., a curved cross-sectional shape as shown in FIG. 5E, a triangular cross-sectional shape, or the like).

The curved cross-sectional shape of the second cavity 537b may assist in aligning the first photonic die 533 in multiple lateral directions relative to the second photonic die 534. During bonding, when the first photonic die 533 is moved toward the second side 511 along the second lateral direction 509, a vertical surface of second protrusion 536b will be positioned at least partially within the second cavity 537b to contact the second side 511 at a single point. As the first photonic die is further moved along the second lateral direction 509, the first photonic die 533 will translate along the first lateral direction 507 as the second contact point 538b moves toward the deepest point in the second cavity 537b, thereby providing alignment in both the first and second lateral directions 507, 509. Additionally, the first contact point 538a may, in conjunction with the second contact point 538b, set the lateral rotational alignment between the first and second photonic dies 533, 534.

In some variations, waveguide facets of two photonic dies may be part of a contact point between the photonic dies. For example, FIG. 5F shows a partial top view of one such variation of an integrated photonic system 540 that includes a first photonic die 542 and a second photonic die 543. The integrated photonic system 540 may be configured and labeled the same as the integrated photonic systems of FIGS. 5A-5E, except that the integrated photonic system 540 includes a first pair of vertical engagement surfaces 544a and a second pair of vertical engagement surfaces 544b, where the first pair of vertical engagement surfaces 544a forms waveguide facets for the first and second sets of waveguides 501a, 503a.

Specifically, for the first pair of vertical engagement surfaces 544a, the second side 511 is shaped to form a protrusion (referred to herein as “first protrusion 545a”) and the first side 510 is shaped to define a cavity (referred to herein as “first cavity 546a”), or vice versa. When the first photonic die 542 is bonded to the second photonic die 543, the first protrusion 545a extends into the first cavity 546a to contact the first side 510 (i.e., at a first contact point 548a). A surface of the first protrusion 545a forms a facet for the second set of waveguides 503a, while a surface of the first side 510 defining the first cavity 546a forms a facet for the first set of waveguides 501a. These facets may be in physical contact to form the first contact point 548a, such that light passes through the first contact point 548a when light is coupled between the first and second photonic dies 542, 543 (e.g., via waveguides 501a, 503a). For example, the first protrusion 545a may have a rectangular cross-sectional shape, and one surface of the rectangular cross-sectional shape may act as the facet(s) for the second set of waveguides 503a. Similarly, the first cavity 546a may have a rectangular cross-sectional shape, and a portion of the first side 510 defining a side of the first cavity 546a may act as the facet(s) for the first set of waveguides 501a.

The second pair of vertical engagement surfaces 544b may be configured in any manner as described herein with respect to FIGS. 5A-5E. In the example shown in FIG. 5F, another portion of the second side 511 is shaped to form a protrusion (referred to herein as “second protrusion 545b”) and the first side 510 is shaped to define a cavity (referred to herein as “second cavity 546b”). The second pair of vertical engagement surfaces 544b may be configured to create two noncontiguous points of contact (referred to herein as “second contact point 548b” and “third contact point 548c”), as described herein. In other instances, the second protrusion 545b may instead be formed in the first side 510 and the second cavity may be defined in the second side 511.

While the integrated photonic systems described with respect to FIGS. 5A-5F show multiple pairs of vertical engagement surfaces defined in the same pair of adjacent sides of photonic dies, it should be appreciated that these pairs of vertical engagement surfaces may be distributed across multiple pairs of adjacent sides of the photonic dies. For example, FIG. 5G shows a partial top view of a variation of an integrated photonic system 550 including a first photonic die 551 and a second photonic die 552. The first photonic die 551 is positioned to extend vertically at least partially into a cavity 553 defined to extend at least partially through the second photonic die 552.

In the variation shown in FIG. 5G, the first photonic die 551 includes a base region 554 (shown in phantom) and an upper region 555, such as described herein. The base region 554 may have a rectangular shape, while the upper region 555 may have a non-rectangular shape. For example, a portion of the upper region 555 may have a wedge shape, or the entire upper region 555 may have a wedge shape. The cavity 553 may also have a non-rectangular shape, and may be sized to receive at least a portion of the upper region 555 therein. For example, in instances where at least a portion of the upper region 555 has a wedge shape, a corresponding portion of the cavity 553 may also have a wedge shape.

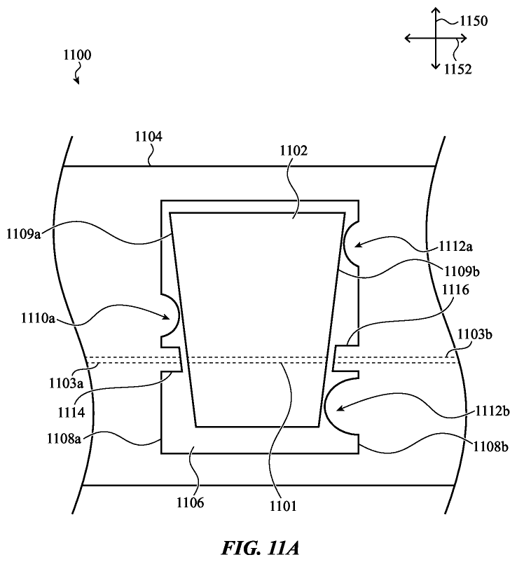

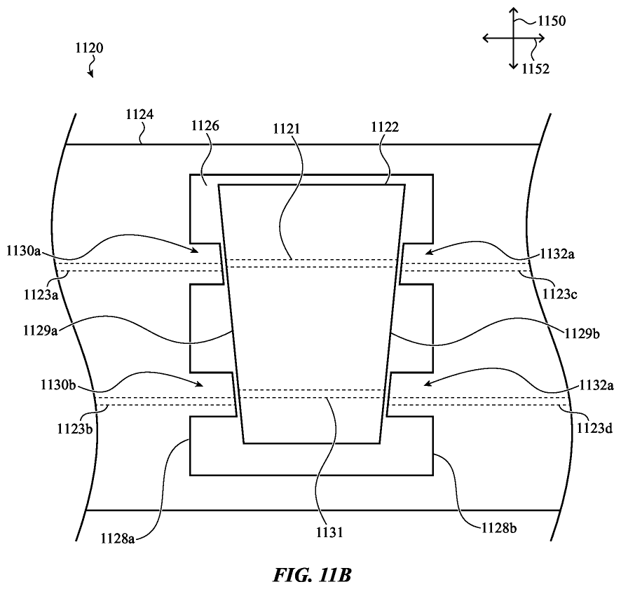

The first photonic die 551 (or the upper region 555 thereof) may include a first side 559a, a second side 559b, and a third side 559c. In the variation shown in FIG. 5G, the first side 559a, second side 559b, and the third side 559c define a wedge-shaped portion of the upper region 555. Specifically, the second side 559b and the third side 559c, which are separated by the first side 559a, are not parallel to each other and are angled such that the second side 559b and the third side 559c are projected to intersect. In this way, the width of the of the first photonic die 551 (or the upper region 555 thereof) decreases in a direction toward the first side 559a. Similarly, the second photonic die 552 may include a first side 558a, a second side 558b, and a third side 558c, each of which may form a portion of the outer perimeter of the cavity 553. In the variation shown in FIG. 5G, the first side 558a, second side 558b, and the third side 558c of the second photonic die 552 define a wedge-shaped portion of the cavity 553. Specifically, the second side 558b and the third side 558c, which are separated by the first side 558a, are not parallel to each other and are angled such that the second side 558b and the third side 558c are projected to intersect. In this way, the width of the of the cavity 553 decreases in a direction toward the first side 558a. The first, second, and third sides 559a-559c of the first photonic die 511 may be adjacent to the first, second, and third sides 558a-558c, respectively, of the second photonic die 512. Additional integrated photonic systems that utilize wedge-shaped first photonic dies are described in more detail herein with respect to FIGS. 11A and 11B.

Some or all of the pairs of adjacent sides of the first and second photonic dies 511, 512 may include one or more pairs of vertical engagement surfaces. For example, in the example shown in FIG. 5G, the first side 556a may be shaped to form a protrusion (referred to herein as “first protrusion 556a”), the second side 556b may be shaped to form a protrusion (referred to herein as “second protrusion 556b”), and the third side 556c may be shaped to form a protrusion (referred to herein as “third protrusion 556c”). When the first photonic die 511 is moved laterally relative to the second photonic die 552 along a lateral direction (e.g., the second lateral direction 509), each of the first through third protrusions 556a-556c may contact a corresponding side of the second photonic die 552. Specifically, the first protrusion 556a may contact the first side 558a of the second photonic die 552 to form a first contact point 557a, the second protrusion 556b may contact the second side 558b of the second photonic die 552 to form a second contact point 557b, and the third protrusion 556c may contact the third side 558c of the second photonic die 552 to form a third contact point 557c. The first through third contact points 557a-557c may collectively provide both directional lateral alignment (e.g., along the first and second lateral directions 507, 509) and rotational lateral alignment as discussed herein, which may align optical components such as waveguides 501a, 503a.

It should be appreciated that the some or all of the protrusions 556a-556c may alternatively be formed in a corresponding side of the second photonic die. For example, FIG. 5H shows a partial top view of a variation of an integrated photonic system 560 including a first photonic die 561 and a second photonic die 562. The first photonic die 561 is positioned to extend vertically at least partially into a cavity 506 defined to extend at least partially through the second photonic die 562. As shown there, the first photonic die 561 (or an upper region thereof) may have a first side 562a and a second side 562b. The second photonic die 562 may also have a first side 563a and a second side 563b (each of which may form a portion of the perimeter of the cavity 506) that are adjacent to the first and second sides 562a, 562b, respectively, of the first photonic die 561.

The first side 563a may be shaped to form one or more protrusions (e.g., a first protrusion 564a and a second protrusion 564b) that are configured to contact the first side 562a to form one or more contact points (e.g., a first contact point 565a and a second contact point 565b, respectively). Similarly, the second side 563b may be shaped to form one or more protrusions (e.g., a third protrusion 564c) that are configured to contact the first side 562a to form one or more contact points (e.g., a third contact point 565c). These non-contiguous contact points may help to align the first and second photonic dies 561, 562 as described herein. Additionally, in some instances the first side 563a of the second photonic die 562 (and/or the first side 563a of the first photonic die 561) may be shaped to form another protrusion (e.g., fourth protrusion 564d) that acts as facet for waveguide 503a and that brings waveguide facets of the first and second photonic dies 561, 562 (e.g., between waveguides 501a, 503a) closer together.

In some variations, a photonic integrated system as described herein may include a standoff structure that acts as a vertical engagement surface. For example, FIGS. 6A and 6B show one such variation of an integrated photonic system 600 including a first photonic die 602 and a second photonic die 604, which may be configured in any manner as described with respect to FIGS. 1A-5H. The second photonic die 604 defines a cavity 606 that extends at least partially therethrough. The first photonic die 602 may be bonded to the second photonic die 604 such that at least the first photonic die 602 extends at least partially into the cavity 606 in a vertical direction 654. This may align a waveguide of the first photonic die 602 (referred to herein as “first waveguide 608”) with a waveguide of the second photonic die 604 (referred to herein as “second waveguide 610”) as described herein.

The first photonic die 602 may be configured to define one or more cavities extending at least partially therethrough. For example, in the example shown in FIGS. 6A and 6B, the first photonic die 602 defines a first cavity 612a and a second cavity 612b in a top side of the first photonic die 602. Similarly, the second photonic die 602 may include one or more standoff structures positioned within the cavity 606. For example, in the example shown in FIGS. 6A and 6B, the second photonic die 602 includes a first post 614a and a second post 614b positioned in the cavity 606. The integrated photonic system may be configured such that, when the first photonic die 602 is bonded to the second photonic die 604, each of the one or more standoff structures extends at least partially into a corresponding cavity of the one or more cavities defined to extend at least partially through the first photonic die 602. In the example shown in FIGS. 6A and 6B, the first post 614a extends at least partially into the first cavity 612a, and the second post 614b extends at least partially in the second cavity 614b.

The integrated photonic system 600 may include one or more pairs of vertical engagement surfaces formed from a vertical surface of one of the standoff structures and a corresponding vertical surface of the cavity into which the standoff structure extends. For example, a vertical surface of the first post 614a may contact a vertical surface of the first cavity 612a to form a single contact point (referred to herein as “first contact point 616a”). Similarly, a vertical surface of the second post 614b contacts two or more vertical surfaces of the second cavity 612b to form two noncontiguous contact points (referred to herein as “second contact point 616b” and “third contact point 616c”). The three noncontiguous contact points may provide translational alignment in multiple lateral directions (e.g., in a first lateral direction 650 and a second lateral direction 652 perpendicular to the first lateral direction 650), as well as rotational alignment around the vertical direction 654 between the first and second photonic dies 602, 604, as described herein. It should be appreciated that the cross-sectional shapes of the standoff structures and the corresponding cavities defined in the first photonic die 602 may have any relative shapes as appropriate to provide a desired number of noncontiguous contact points between vertical surfaces thereof.

Some or all of the standoff structures may optionally also be used to align the first and second photonic dies 602, 604 along the vertical direction 654. Specifically, the integrated optical system 600 may be configured such that a top surface of a given standoff contacts the first photonic die 602, thereby limiting how far the first photonic die 602 may be inserted into the cavity 606. For example, as shown in FIG. 6B, a top surface of the first post 612a may contact a bottom surface of the first cavity 614a to limit how for the first photonic die 602 may be inserted into the cavity 606. Additionally or alternatively, the second post 61b may contact a bottom surface of the second cavity 614b, which may similarly contribute to the alignment of the dies in the vertical direction 654.

In other variations, the first die may include one or more ridges or other structures that are configured to engage with a vertical surface of a standoff structure. For example, FIGS. 7A and 7B show one such variation of an integrated photonic system 700 including a first photonic die 702 and a second photonic die 704, which may be configured in any manner as described with respect to FIGS. 1A-6B. The second photonic die 704 defines a cavity 706 that extends at least partially through the second photonic die 704. The first photonic die 702 may be bonded to the second photonic die 704 such that at least the first photonic die 702 extends at least partially into the cavity 706 in a vertical direction 754. This may align a waveguide of the first photonic die 702 (referred to herein as “first waveguide 707”) with a waveguide of the second photonic die 704 (referred to herein as “second waveguide 708”) as described herein.

The first photonic die 702 may be configured to define one or more ridges extending from a top side thereof. For example, in the example shown in FIGS. 7A and 7B, the first photonic die 702 defines a first ridge 710. Similarly, the second photonic die 704 may include one or more standoff structures positioned within the cavity 706. For example, in the example shown in FIGS. 7A and 7B, the second photonic die 704 includes a first post 712 positioned in the cavity 706. The integrated photonic system 700 may be configured such that, when the first photonic die 702 is bonded to the second photonic die 704, a vertical surface of the first post 712 contacts a vertical surface of the first ridge 710. Collectively, the first post 712 and first ridge 710 form a pair of vertical engagement surfaces, and provide a first contact point 720a between the first and second photonic dies 702, 704. For example, relative movement between the first and second photonic dies 702, 704 along a first lateral direction 750 may cause a vertical surface of the first post 712 to contact a corresponding vertical surface of the first ridge 710. Additionally, a top surface of the first post 712 may contact a corresponding surface of the first photonic die 702 to align the first and second photonic dies 702, 704 along a vertical direction 754 as discussed herein.

The integrated photonic system 700 may include multiple pairs of ridges and posts, where each pair provides an additional pair of vertical engagement systems and a corresponding contact point therebetween. Additional contact points may help to provide lateral alignment in additional lateral directions (e.g., along a second lateral direction 752) and/or lateral rotational alignment around the vertical direction 754. Additionally or alternatively, the integrated photonic system 700 may be configured to include one or more pairs of vertical engagement systems as described with respect to FIGS. 5A-5H, 8A-8F, and 10-11B. For example, the integrated photonic system 700 may include adjacent sides of the first and second photonic dies 702, 704 (referred to herein respectively as first surface 714 and second surface 716). The first portion of the second surface 716 may be shaped to form a first protrusion 718a, and a second portion of the second surface 716 may be shaped to form a second protrusion 718b. The first and second protrusions 718a, 718b, may each contact the first surface 714 to provide a corresponding contact point (e.g., a second contact point 720b and a third contact point 720c). These noncontiguous contact points may assist in providing lateral alignment along the second lateral direction 752 as well as lateral rotational alignment around the vertical direction 754.

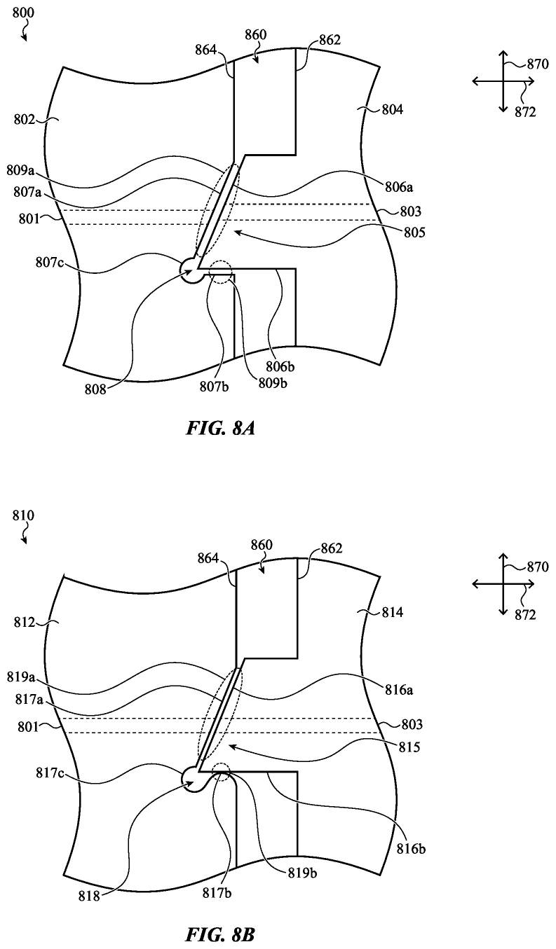

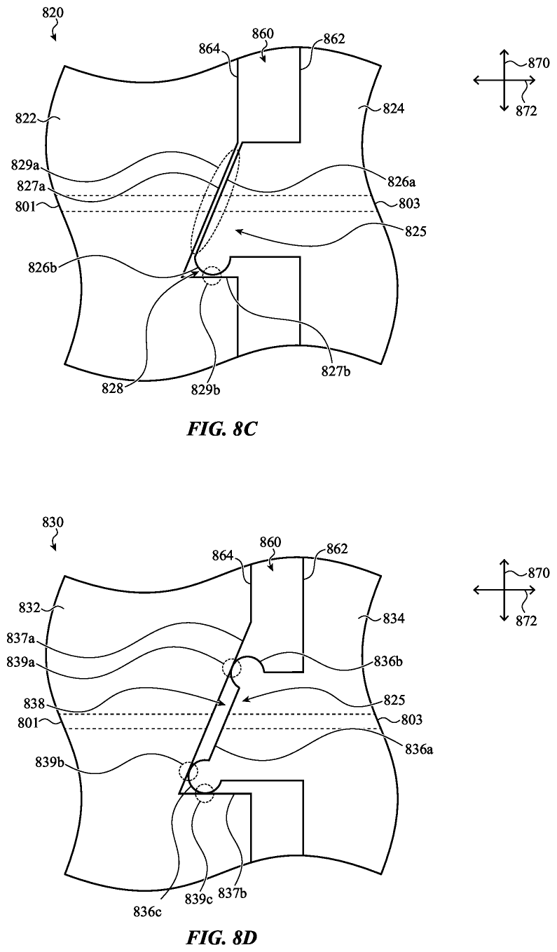

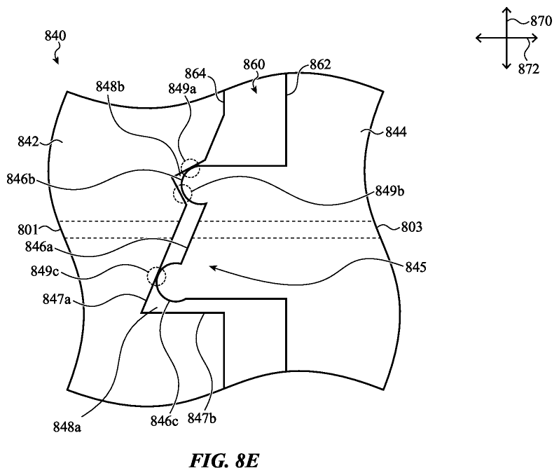

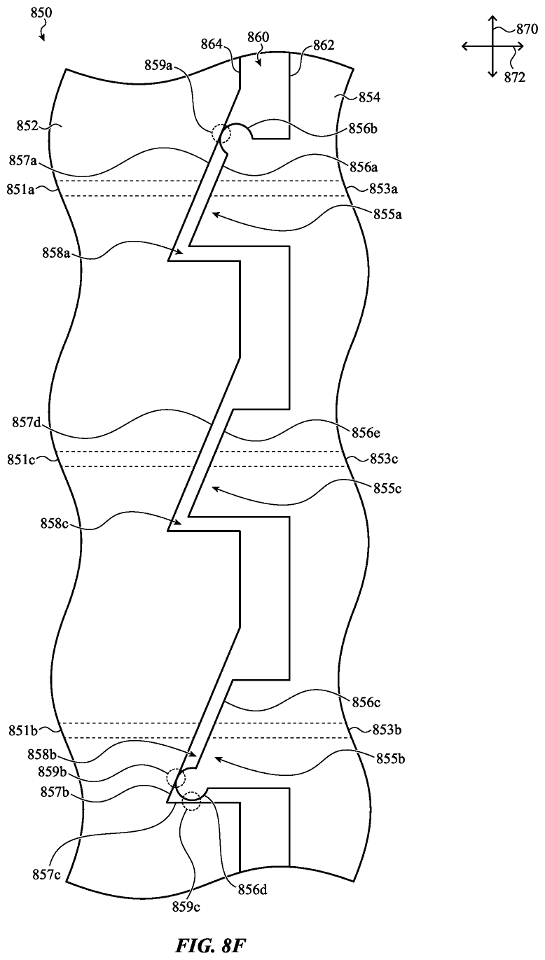

In some variations, a protrusion formed by a photonic die may both i) form a facet for one or more waveguides, and ii) provide multiple noncontiguous contact points with an adjacent side of another photonic die. FIGS. 8A-8F show multiple variations of integrated photonic systems having these facets. For example, FIG. 8A shows a variation of an integrated photonic system 800 having a first photonic die 802 and a second photonic die 804, which may be configured in any manner as described herein with respect to FIGS. 1A-7B. The second photonic die 804 may define a cavity 860, and the first photonic die 802 may be bonded to the second photonic die 804 such that the first photonic die 802 extends at least partially into the cavity 860, such as described herein. When the first photonic die 802 is connected to the second photonic die 804, a vertical side of the first photonic die 802 (“first side 864”) is positioned adjacent to a corresponding vertical side of the second photonic die 804 (“second side 862”), and the first and second sides 864, 862 may contact each other at multiple non-contiguous contact points. This may assist in translational and/or rotational lateral alignment of the first and second photonic dies 802, 804 as described herein.

A portion of the second side 862 is shaped to form a protrusion 805 that includes at least a first surface 806a and a second surface 806b (both of which are vertical surfaces). A portion of the first side 864 is shaped to define a cavity 808, such that the protrusion 805 extends at least partially into the cavity 808 when the first photonic die 802 is bonded to the second photonic die 804. The portion of the first side 864 that defines the cavity 808 may include at least a first surface 807a and a second surface 807b. The first surface 807a of the first photonic die 802 may act as a waveguide facet for at least one waveguide of the first photonic die 802 (e.g., first waveguide 801) and the first surface 806a of the protrusion 805 may act as a waveguide facet for at least one waveguide of the second photonic die 804 (e.g., second waveguide 803). It should be appreciated that in other instances, the second side 864 may instead be shaped to form the protrusion 805 and the first side 862 is shaped to define the cavity 808.

When the first photonic die 802 is bonded to the second photonic die 804, the first surface 807a of the first side 864 contacts the first surface 806a of the protrusion 805 to form a first contact point 809a between the first side 864 and the second side 862 (though these surfaces are not depicted as touching in FIG. 8A). In other words, the first surface 807a of the first side 864 and the first surface 806a of the protrusion 805 form a first pair of vertical engagement surfaces as discussed herein.

Similarly, when the first photonic die 802 is bonded to the second photonic die 804, the second surface 807b of the first side 864 contacts the second surface 806b of the protrusion 805 to form a second contact point 809b between the first and second sides 864, 862 (though these surfaces are not shown as touching in FIG. 8A). In other words, the first surface 807a of the first side 864 and the first surface 806a of the protrusion 805 form a first pair of vertical engagement surfaces as discussed herein. Collectively, the first and second contact points 809a, 809b may act to set the lateral alignment in multiple lateral directions (e.g., along a first lateral direction 870 and an orthogonal second lateral direction 872), as well as lateral rotational alignment, between the first and second photonic dies 802, 804.

In the variation shown in FIG. 8A, the portion of the first side 864 that defines the cavity 808 further includes a third surface 807c positioned between the first and second surfaces 807a, 807b. This third surface may be shaped (e.g., the third surface 807c is shown in FIG. 8A as including a concave curve) so that a corner of the protrusion 805 connecting the first surface 806a to the second surface 806b does not contact the first side 864 when the first photonic die 802 is bonded to the second photonic die 804. This may make the integrated optical system more sensitive to manufacturing tolerances.

FIG. 8B shows another variation of an integrated photonic system 810 having a first photonic die 812 and a second photonic die 814. The second photonic die 814 may define a cavity 860 that extends at least partially therethrough, and the first photonic die 812 may be bonded to the second photonic die 814 such that the first photonic die 812 extends at least partially into the cavity 860, such as described herein. When the first photonic die 812 is connected to the second photonic die 814, a vertical side of the first photonic die 812 (“first side 864”) is positioned adjacent to a corresponding vertical side of the second photonic die 814 (“second side 862”), and the first and second sides 864, 862 may contact each other at multiple non-contiguous contact points. This may assist in translational and/or rotational lateral alignment of the first and second photonic dies 812, 814 as described herein.

A portion of the second side 862 is shaped to form a protrusion 815 that includes at least a first surface 816a and a second surface 816b (both of which are vertical surfaces). A portion of the first side 864 that includes a first surface 817a, a second surface 817b, and a third surface 817c may define a cavity 818. The first surface 817a of the first photonic die 812 may act as a waveguide facet for at least one waveguide of the first photonic die 812 (e.g., first waveguide 801) and the first surface 816a of the protrusion 815 may act as a waveguide facet for at least one waveguide of the second photonic die 814 (e.g., second waveguide 803). When the first and second photonic dies 812, 814 are connected, the first surface 817a of the first side 864 contacts the first surface 816a of the protrusion 815 to form a first contact point 819a, and the second surface 817b of the first side 864 contacts the second surface 816b of the protrusion 815 to form a second contact point 819b between the first and second sides 864, 862. These structures may be configured the same as the corresponding structures of the integrated photonic system 800 of FIG. 8A, except the second surface 817b has a convex curve (whereas the second surface 807b in FIG. 8A was flat). This reduces the size of the second contact point 819b as compared to the second contact point 809b of FIG. 8A, which may improve the precision of the alignment between the first and second photonic dies 812, 814.

FIG. 8C shows another variation of an integrated photonic system 820 having a first photonic die 822 and a second photonic die 824. The second photonic die 824 may define a cavity 860 that extends at least partially therethrough, and the first photonic die 822 may be bonded to the second photonic die 824 such that the first photonic die 822 extends at least partially into the cavity 860, such as described herein. When the first photonic die 822 is connected to the second photonic die 824, a vertical side of the first photonic die 822 (“first side 864”) is positioned adjacent to a corresponding vertical side of the second photonic die 824 (“second side 862”), and the first and second sides 864, 862 may contact each other at multiple non-contiguous contact points. This may assist in translational and/or rotational lateral alignment of the first and second photonic dies 822, 824 as described herein.

A portion of the second side 862 is shaped to form a protrusion 825 that includes at least a first surface 826a and a second surface 826b (both of which are vertical surfaces). A portion of the first side 864 includes a first surface 827a and a second surface 827b that may at least partially define a cavity 828. The portion of the first side 864 is shown without a third surface positioned between the first and second surface 827a, 827b, though it should be appreciated that this portion of the first side 864 may include such a third surface if desired. The first surface 827a of the first photonic die 822 may act as a waveguide facet for at least one waveguide of the first photonic die 822 (e.g., first waveguide 801) and the first surface 826a of the protrusion 825 may act as a waveguide facet for at least one waveguide of the second photonic die 824 (e.g., second waveguide 803). When the first and second photonic dies 822, 824 are connected, the first surface 827a of the first side 864 contacts the first surface 826a of the protrusion 825 to form a first contact point 829a, and the second surface 827b of the first side 864 contacts the second surface 826b of the protrusion 825 to form a second contact point 829bbetween the first and second sides 864, 862. These structures may be configured the same as the corresponding structures of the integrated photonic system 800 of FIG. 8A, except the second surface 826b of the protrusion 825 is formed with a convex curve (whereas the second surface 806b in FIG. 8A was flat). This reduces the size of the second contact point 829b as compared to the second contact point 809b of FIG. 8A, which may improve the precision of the alignment between the first and second photonic dies 822, 824.

The variations of the integrated photonic systems described with respect to FIGS. 8A-8C each may result in the waveguide facets of the first and second waveguides contacting each other (i.e., as part of a first contact point). However, in some instances it may be desirable to maintain a gap between these facets (e.g., to reduce potential damage to these facets as the photonic dies laterally moved during alignment). For example, FIG. 8D shows a variation of an integrated photonic system 830 having a first photonic die 832 and a second photonic die 834, which may be configured in any manner as described herein with respect to FIGS. 1A-7B. The second photonic die 834 may define a cavity 860 extending at least partially therethrough, and the first photonic die 832 may be bonded to the second photonic die 834 such that the first photonic die 832 extends at least partially into the cavity 860, such as described herein. When the first photonic die 832 is connected to the second photonic die 834, a vertical side of the first photonic die 832 (“first side 864”) is positioned adjacent to a corresponding vertical side of the second photonic die 834 (“second side 862”), and the first and second sides 864, 862 may contact each other at multiple non-contiguous contact points. This may assist in translational and/or rotational lateral alignment of the first and second photonic dies 832, 834 as described herein.

A portion of the second side 862 is shaped to form a protrusion 835 that includes at least a first surface 836a positioned between a second surface 836b and a third surface 836c (all of which are vertical surfaces). A portion of the first side 864 is shaped to define a cavity 838, such that the protrusion 835 extends at least partially into the cavity 838 when the first photonic die 832 is bonded to the second photonic die 834. The portion of the first side 864 that defines the cavity 838 may include at least a first surface 837a and a second surface 837b. The first surface 837a of the first photonic die 832 may act as a waveguide facet for at least one waveguide of the first photonic die 832 (e.g., first waveguide 801) and the first surface 836a of the protrusion 805 may act as a waveguide facet for at least one waveguide of the second photonic die 834 (e.g., second waveguide 803).

When the first photonic die 832 is bonded to the second photonic die 834, the second and third surfaces 836b, 836c of the protrusion 835 each contact the first side 864 to form at least one contact point between the first and second photonic dies 832, 834. For example, in the variation shown in FIG. 8D, the second surface 836c of the protrusion contacts the first surface 837a of the first side 864 to form a contact point (referred to herein as “first contact point 839a”). Similarly, the second surface 836b of the protrusion contacts the first surface 837a of the first side 864 to form a contact point (referred to herein as “second contact point 839b”). Additionally, the third surface 836c of the protrusion 825 contacts the second surface 837b of the first side 864 to form a contact point (referred to herein as “third contact point 839c”). Accordingly, at each of these noncontiguous contact points, the first and second sides 864, 862 form a pair of vertical engagement surfaces. In some variations, the second and third surfaces 836b, 836c of the protrusion 835 may each include a convex curve.

Collectively, the first, second, and third contact points 839a-839c may act to set the lateral alignment in multiple lateral directions (e.g., along a first lateral direction 870 and an orthogonal second lateral direction 872), as well as lateral rotational alignment, between the first and second photonic dies 832, 834. Additionally, the first and second contact points 839a, 839b, may define a gap between the first surface 836a of the protrusion 835 and the first surface 837a of the first side 862 (thereby providing a separation between the waveguide facets for the first and second waveguides 801, 803.

FIG. 8E shows a variation of an integrated photonic system 840 having a first photonic die 842 and a second photonic die 844, which may be configured in any manner as described herein with respect to FIGS. 1A-7B. The second photonic die 844 may define a cavity 860 extending at least partially therethrough, and the first photonic die 842 may be bonded to the second photonic die 844 such that the first photonic die 842 extends at least partially into the cavity 860, such as described herein. When the first photonic die 842 is connected to the second photonic die 844, a vertical side of the first photonic die 842 (“first side 864”) is positioned adjacent to a corresponding vertical side of the second photonic die 844 (“second side 862”), and the first and second sides 864, 862 may contact each other at multiple non-contiguous contact points. This may assist in translational and/or rotational lateral alignment of the first and second photonic dies 842, 844 as described herein.

A portion of the second side 862 is shaped to form a protrusion 845 that includes at least a first surface 846a positioned between a second surface 846b and a third surface 846c (all of which are vertical surfaces, and may be configured the same as corresponding surface of the protrusion 835 of FIG. 8D). A portion of the first side 864 includes a first surface 847a and a second surface 847b and is shaped to define a cavity having a first portion 848a. The first side 864 is further shaped such that the cavity includes a second portion 848b that is recessed relative to the first surface 847a. When the first photonic die 842 is bonded to the second photonic die 844, the second surface 846b of the protrusion extends at least partially into the second portion 848b of the cavity to contact the first side 864 at one or more noncontiguous contact points (e.g., a first contact point 849a and a second contact point 849b). Additionally, the third surface 846c of the protrusion extends at least partially into the first portion 848a of the cavity to contact the first surface 847a of the first side 864 at a single contact point (e.g., a third contact point 849c).

The first surface 847a of the first photonic die 842 may act as a waveguide facet for at least one waveguide of the first photonic die 842 (e.g., first waveguide 801) and the first surface 846a of the protrusion 845 may act as a waveguide facet for at least one waveguide of the second photonic die 844 (e.g., second waveguide 803). Collectively, the first, second, and third contact points 849a-849c may act to set the lateral alignment in multiple lateral directions (e.g., along a first lateral direction 870 and an orthogonal second lateral direction 872), as well as lateral rotational alignment, between the first and second photonic dies 842, 844. Additionally, these contact points 849a-849c, may define a gap between the first surface 846a of the protrusion 845 and the first surface 847a of the first side 862 (thereby providing a separation between the waveguide facets for the first and second waveguides 801, 803.

In some variations, the contact points may be distributed between two or more protrusions, each forming a corresponding pair of waveguide facets. FIG. 8F shows a variation of an integrated photonic system 850 having a first photonic die 852 and a second photonic die 854, which may be configured in any manner as described herein with respect to FIGS. 1A-7B. The second photonic die 854 may define a cavity 860 extending at least partially therethrough, and the first photonic die 852 may be bonded to the second photonic die 854 such that the first photonic die 852 extends at least partially into the cavity 860, such as described herein. When the first photonic die 852 is connected to the second photonic die 854, a vertical side of the first photonic die 852 (“first side 864”) is positioned adjacent to a corresponding vertical side of the second photonic die 854 (“second side 862”), and the first and second sides 864, 862 may contact each other at multiple non-contiguous contact points. This may assist in translational and/or rotational lateral alignment of the first and second photonic dies 852, 854 as described herein.

A portion of the second side 862 is shaped to form multiple protrusions, such as a protrusion 855a and a second protrusion 855b, that are each configured to contact the first side 864 (and form one or more noncontiguous contact points therewith). The second side 862 may optionally be further shaped to form one or more additional protrusions (e.g., a third protrusion 855c) that do not contact the first side 864. Additionally, a portion of the first side 864 may include multiple surfaces configured to define a plurality of cavities.

For example, the first side 864 may include at least a first surface 857a that at least partially defines a first cavity 858a. When the first and second photonic dies 852, 854 are bonded together, the first protrusion 855a extends at least partially into the first cavity 858a to contact the first side 864. In the variation shown in FIG. 8F, the first protrusion 855a includes a first surface 856a (shown in FIG. 8F as being flat) and a second surface 856b (shown in FIG. 8F as having a convex curve), where the second surface 856b contacts the first surface 857a to form a first contact point 859a between the first and second photonic dies 852, 854 (these surfaces also form a first pair of vertical engagement surfaces). The first surface 857a of the first photonic die 852 may act as a waveguide facet for at least one waveguide of the first photonic die 852 (e.g., a first waveguide 851a) and the first surface 856a of the first protrusion 855a may act as a waveguide facet for at least one waveguide of the second photonic die 854 (e.g., second waveguide 853a).

Similarly, the first side 864 may include at least a second surface 857b and a third surface 857c that at least partially define a second cavity 858b. When the first and second photonic dies 852, 854 are bonded together, the second protrusion 855b extends at least partially into the second cavity 858b to contact the first side 864. In the variation shown in FIG. 8F, the second protrusion 855b includes a first surface 856c (shown in FIG. 8F as being flat) and a second surface 856d (shown in FIG. 8F as having a convex curve), where the second surface 856d of the second protrusion 855b contacts the second surface 857b to form a second contact point 859b between the first and second photonic dies 852, 854 (these surfaces also form a second pair of vertical engagement surfaces). Additionally, the second surface 856d of the second protrusion 855b contacts the third surface 857c to form a third contact point 859c between the first and second photonic dies 852, 854 (these surfaces also form a third pair of vertical engagement surfaces). The second surface 857b of the first photonic die 852 may act as a waveguide facet for at least one waveguide of the first photonic die 852 (e.g., a third waveguide 851b) and the first surface 856a of the second protrusion 855b may act as a waveguide facet for at least one waveguide of the second photonic die 854 (e.g., a fourth waveguide 853b).

Optionally, the first side 864 may include at least a fourth surface 857d that at least partially defines a third cavity 858c. The third cavity may be positioned between the first and second cavities 858a, 858b, but need not be. When the first and second photonic dies 852, 854 are bonded together, the third protrusion 855c extends at least partially into the third cavity 858c, but does not contact the first side 864. The fourth surface 857d of the first photonic die 852 may act as a waveguide facet for at least one waveguide of the first photonic die 852 (e.g., a fifth waveguide 851c) and a first surface 856e of the third protrusion 855c may act as a waveguide facet for at least one waveguide of the second photonic die 854 (e.g., a sixth waveguide 853c).

Collectively, the first, second, and third contact points 859a-859c may act to set the lateral alignment in multiple lateral directions (e.g., along a first lateral direction 870 and an orthogonal second lateral direction 872), as well as lateral rotational alignment, between the first and second photonic dies 852, 854. Additionally, these contact points 849a-849c, may define a respective gap between the first surface of each protrusion and the first side 864, to provide separation between each pair of waveguide facets (e.g., between the waveguide facets for first and second waveguides 851a, 853a, between the waveguide facets for third and fourth waveguides 851b, 853b, and between the waveguide facets for fifth and sixth waveguides 851c, 853c).

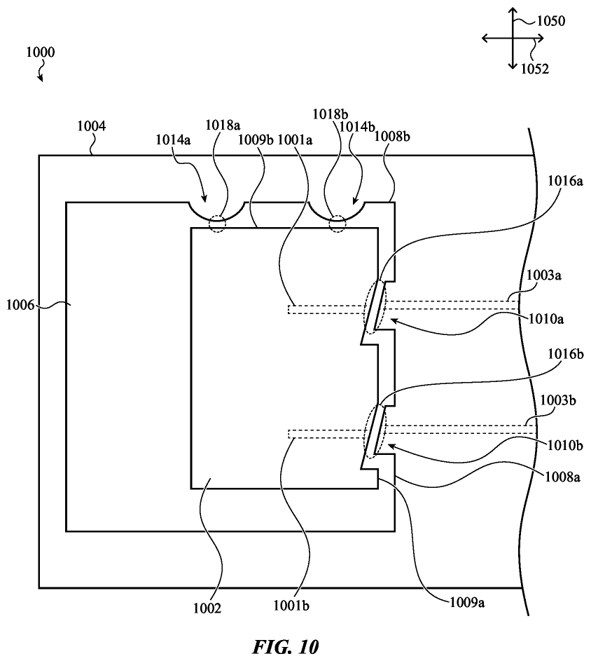

In some variations, a photonic die may include a protrusion formed by a photonic die may both i) form a facet for one or more waveguides, and ii) provide multiple noncontiguous contact points with an adjacent side of another photonic die. For example, FIG. 10 shows a variation of an integrated photonic system 1000 having a first photonic die 1002 and a second photonic die 1004, which may be configured in any manner as described herein with respect to FIGS. 1A-8F. The second photonic die 1004 may define a cavity 1006, and the first photonic die 1002 may be bonded to the second photonic die 1004 such that the first photonic die 1002 extends at least partially into the cavity 1006, such as described herein. When the first photonic die 1002 is connected to the second photonic die 1004, two vertical sides of the first photonic die 1002 are positioned adjacent to two corresponding vertical sides of the second photonic die 1004. Specifically, a first vertical side 1009a of the first photonic die 1002 (also referred to herein as “first side 1009a”) is positioned adjacent to and in contact with a corresponding first vertical side 1008a of the second photonic die 1004 (also referred to herein as “second side 1008a”). A second vertical side 1009b of the first photonic die 1002 (also referred to herein as “third side 1009b”) is positioned adjacent to and in contact with a corresponding second vertical side 1008b of the second photonic die 1004 (also referred to herein as “fourth side 1008b”). The first side 1009a and the second side 1008a may contact each other at one or more non-contiguous contact points, and the third side 1009b and the fourth side 1008b may contact each other at one or more non-contiguous contact points. Collectively, these contact points may assist in translational and/or rotational lateral alignment of the first and second photonic dies 1002, 1004 as described herein.

One or both of the first and second sides 1009a, 1008a is shaped to form a set of protrusions. For example, in the variation shown in FIG. 10, a first portion of the first side 1008a of the second photonic die 1004 is shaped to form a first protrusion 1010a. A first portion of the first side 1009a of the first photonic die 1002 is shaped to define a first cavity 1012a, such that the first protrusion 1010a extends at least partially into the first cavity 1012a when the first photonic die 1002 is bonded to the second photonic die 1004. In some of these variations, a second portion of the first side 1008a of the second photonic die 1004 is shaped to from a second protrusion 1010b and a second portion of the first side 1009a of the first photonic die 1002 is shaped to define a second cavity 1012b, such that the second protrusion 1010b extends at least partially into the second cavity 1012b when the first photonic die 1002 is bonded to the second photonic die 1004. In other variations, one or both of the first and second protrusions 1010a, 1010b may instead be defined in the first side 1009a of the first photonic die 1002, in which instance the corresponding first cavity 1012a and/or second cavity 1012b is instead defined in the first side 1008a of the second photonic die 1004.

A surface of the first side 1009a that defines the first cavity 1012a may act as a facet for a first waveguide 1001a of the first photonic die 1002, and a surface of the second side 1008a that defines the first protrusion 1010a may act as a facet for a first waveguide 1003a of the second photonic die 1004. The first protrusion 1010a may contact the first side 1009a of the first photonic die 1002 at one or more non-contiguous contact points (e.g., a first contact point 1016a). For example, the first protrusion 1010a and the first cavity 1012a may be designed in any manner such as described with respect to the integrated photonic systems described with respect to FIGS. 8A-8F.

A surface of the first side 1009a that defines the second cavity 1012b may act as a facet for a second waveguide 1001b of the first photonic die 1002, and a surface of the second side 1008a that defines the second protrusion 1010b may act as a facet for a second waveguide 1003b of the second photonic die 1004. The second protrusion 1010b may contact the first side 1009a of the first photonic die 1002 at one or more non-contiguous contact points (e.g., at a second contact point 1016b). Similarly, the second protrusion 1010b and the second cavity 1012b may be designed in any manner such as described with respect to the integrated photonic systems described with respect to FIGS. 8A-8F.

Additionally, one or both of the third or fourth sides 1009b, 1008b is shaped to form a second set of protrusions. For example, in the variation shown in FIG. 10, the second side 1008b of the second photonic die 1004 is shaped to define a set of protrusions 1014a-1014b. The set of protrusions 1014a-1014b includes a first protrusion 1014a that contacts the second side 1009b of the first photonic die 1002 at a third contact point 1018a. In some variations, the set of protrusions 1014a-1014b includes a second protrusion 1014a that contacts the second side 1009b of the first photonic die 1002 at a fourth contact point 1018a. The first and second contact points 1016a, 1016b and the third and fourth contact points 1018a, 1018b, may facilitate alignment in multiple lateral directions (e.g., along a first lateral direction 1050 and an orthogonal second lateral direction 1052) as well as lateral rotational alignment, between the first photonic die 1002 and the second photonic die 1004.

While only one side of each of the first and second photonic die 1002, 1004 acts as a facet for waveguides of the integrated photonic system 1000, it should be appreciated that in other variations multiple sides of a given photonic die may act as facets for waveguides of that photonic die. For example, FIGS. 11A and 11B show examples of two variations of integrated optical systems that provide alignment relative to waveguides positioned on opposite sides of a photonic die. FIG. 11A shows a variation of an integrated photonic system 1100 having a first photonic die 1102 and a second photonic die 1104, which may be configured in any manner as described herein with respect to FIGS. 1A-10. The second photonic die 1104 may define a cavity 1106, and the first photonic die 1102 may be bonded to the second photonic die 1104 such that the first photonic die 1102 extends at least partially into the cavity 1106, such as described herein.

The first photonic die 1102 includes a first pair of vertical sides, including a first side 1109a and a second side 1109b, positioned on opposite sides of the first photonic die 1102. Similarly, the second photonic die 1104 includes a second pair of vertical sides, including first side 1108a and a second side 1108b, that define opposite sides of the cavity 1106. When the first photonic die 1102 is positioned to extend at least partially into the cavity 1106, the first side 1109a of the first photonic die 1102 is adjacent to and faces the first side 1108a of the second photonic die 1104, and the second side 1109b of the first photonic die 1102 is adjacent to and faces the second side 1108b of the second photonic die 1104.

To facilitate alignment between the first photonic die 1102 relative to the second photonic die 1104 (e.g., along a first lateral direction 1150 and an orthogonal second lateral direction 1152, as well as lateral rotational alignment between the photonic dies), the first side 1109a of the first photonic die 1102 may contact the first side 1108a of the second photonic die 1104 and the second side 1109b of the first photonic die 1102 may contact the second side 1108b of the second photonic die 1104. Specifically, a portion of the first photonic die 1102 that includes the first and second sides 1109a, 1109b may have a wedge shape (which may include wedge-shaped portion of an entire height of the first photonic die 1102 or a wedge-shaped upper region of the first photonic die 1102 as described in more detail herein), such that the first and second sides 1109a, 1109b are projected to intersect. Accordingly, the width of the first photonic die 1102 (or a wedge-shaped portion thereof) decreases along direction 1152. When the first photonic die 1102 is moved along this direction 1152, contact between the first and second photonic dies 1102, 1104 may facilitate both rotational and translational alignment between the first and second photonic dies 1102, 1104.

For example, in the variation shown in FIGS. 11A, the first side 1108a of the second photonic die 1104 is shaped to define a first set of protrusions (shown in FIG. 11A as a single protrusion 1110a) and the second side 1108b of the second photonic die 1104 is shaped to define a second set of protrusions (shown in FIG. 11A as a first protrusion 1112a and a second protrusion 1112b). As the first photonic die 1102 is moved relative to the second photonic die 1104 along the direction 1152, each of these protrusions will contact the first photonic die 1102 at a corresponding contact point. Specifically, the protrusion 1110a defined from the first side 1108a of the second photonic die 1104 contacts the first side 1109a of the first photonic die 11092 at a first contact point, and the first and second protrusions 1112a, 1112b defined from the second side 1108b of the second photonic die 1104 contacts the second side 1109b of the first photonic die 1102 at respective second and third contact points. These contact points may limit how far the first photonic die 1102 may be moved along direction 1152 and may further set the relative alignment between the photonic dies along direction 1150. While each protrusion is shown as having a curved cross-sectional shape, it should be appreciated that protrusions of the first and second sets of protrusions may have any suitable cross-sectional shape such as described herein. Additionally, it should also be appreciated that some or all of these protrusions may instead be defined form the first and/or second sides 1109a, 1109b of the first photonic die 1102.

Alignment between the photonic dies may align one or more waveguides of the first photonic die 1102 relative to one or move waveguides of the second photonic die 1104. Specifically, the first side 1109a of the first photonic die 1102 acts a facet for at least one waveguide (e.g., waveguide 1101) and the second side 1109b of the first photonic die 1102 acts a facet for at least one waveguide (e.g., waveguide 1101). While the first and second sides 1109a, 1109b of the first photonic die 1102 are shown in FIG. 11A as being facets for a common waveguide 1101, it should be appreciated that in other instances the different sides may act as facets for different waveguides or different combinations of waveguides. Similarly, the first side 1108a of the second photonic die 1104 may act as a facet for a first waveguide 1103a (which may be aligned with a waveguide of the first photonic die 1102 such as waveguide 1101) and the second side 1108b of the second photonic die 1104 may act as a facet for a second waveguide 1103b (which may be aligned with a waveguide of the first photonic die 1102 such as waveguide 1101).

In some variations, one or more sides of the photonic dies may be shaped to define additional protrusions that act as waveguide facets. For example, in the variation shown in FIG. 11A, the first side 1108a of the second photonic die 1104 is shaped to define an additional protrusion 1114 that acts a facet for waveguide 1103a. Similarly, the second side 1108b of the second photonic die 1104 is shaped to define an additional protrusion 1116 that acts a facet for waveguide 1103b. These protrusions 1114, 1116 may act to bring the waveguide facets of the first and second photonic dies 1102, 1104 closer together, such as described in more detail herein. In some variations, the protrusions 1114 and 1116 do not contact the first photonic die 1112.

In other variations, a protrusion may both act as a waveguide facet and contact the first photonic die. For example, FIG. 11B shows a variation of another variation of an integrated photonic system 1120 having a first photonic die 1122 and a second photonic die 1124. The first photonic die 1122 includes first and second sides 1129a, 1129b that define opposite sides of a wedge-shaped portion of the first photonic die 1122, and the second photonic die 1124 includes first and second sides 1128a, 1128b that define opposite sides of a cavity 1126, such as described in more detail with respect to FIG. 11A. The first side 1128a of the second photonic die 1124 is shaped to define a first set of protrusions 1130a-1130b, each of which acts a facet for one or more waveguides and contacts a first side 1129a of the first photonic die 1122 when the first photonic die 1122 is bonded to the second photonic die 1124. For example, in the variation shown in FIG. 11B, the first set of protrusions 1130a-1130b includes a first protrusion 1130a that acts a waveguide facet for a first waveguide 1123a and a second protrusion 1130b that acts a waveguide facet for a second waveguide 1123b. Each protrusion of the first set of protrusions 1130a-1130b may be configured to contact the first side 1129a of the first photonic die 1122 in any manner as described herein with respect to FIGS. 8A-8F.

Similarly, the second side 1128b of the second photonic die 1124 is shaped to define a second set of protrusions 1132a-1132b, each of which acts a facet for one or more waveguides and contacts a second side 1129b of the first photonic die 1122 when the first photonic die 1122 is bonded to the second photonic die 1124. For example, in the variation shown in FIG. 11B, the second set of protrusions 1132a-1132b includes a first protrusion 1132a that acts a waveguide facet for a third waveguide 1123c and a second protrusion 1132b that acts a waveguide facet for a fourth waveguide 1123d. Each protrusion of the second set of protrusions 1132a-1132b may be configured to contact the second side 1129b of the first photonic die 1122 in any manner as described herein with respect to FIGS. 8A-8F.

Contact between the first set of protrusions 1130a-1130b and the first side 1129a of the first photonic die 1122, as well as contact between the second set of protrusions 1132a-1132b and the second side 1129a of the first photonic die 1122 may align the first and second photonic dies 1122, 1124 along multiple lateral directions (e.g., along a first lateral direction 1050 and an orthogonal second lateral direction 1052), as well as rotationally align the first and second photonic dies 1122, 1124. This may also align the waveguides of the first photonic die 1122 with waveguides of the second photonic die 1124. For example, in the variation shown in FIG. 11B,, the first side 1129a of the first photonic die 1122 acts a facet for at least one waveguide (e.g., a first waveguide 1121 and a second waveguide 1131 of the first photonic die 1122) and the second side 1129b of the first photonic die 1122 acts a facet for at least one waveguide (e.g., the first and second waveguides 1121, 1131 of the first photonic die 1122). In the variation shown in FIG. 11B, the first and third waveguides 1123a, 1123c of the second photonic die 1124 are aligned with the first waveguide 1121 of the first photonic die 1122, and the second and fourth waveguides 1123b, 1123d of the second photonic die 1124 are aligned with the second waveguide 1131 of the first photonic die 1122.

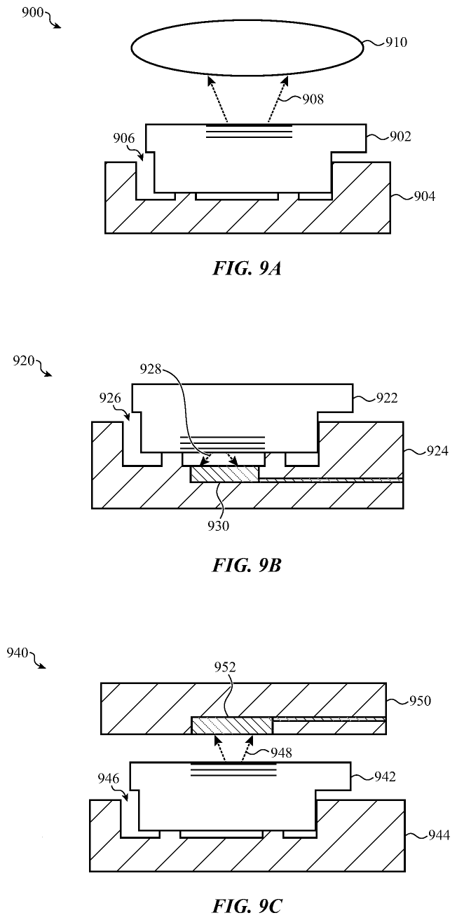

The integrated photonic systems described herein with respect to FIGS. 1A-8F and 10-11B are each described as transferring light between vertical surfaces of two photonic dies, but it should be appreciated that the alignment techniques described with respect to these figures may be applied to any suitable pair of photonic dies. For example, FIG. 9A shows one variation of an integrated photonic system 900 in which a first photonic die 902 is bonded to, laterally aligned with, and at least partially positioned in a cavity 906 defined in a second photonic die 904 (shown in cross section) using any of the techniques described herein, except that light is not transferred between the first and second photonic dies 902, 904. For example, the first photonic die 902 may be configured to emit light 908 from a horizontal surface thereof, which may interact with one or more additional optical components (e.g., a lens 910) of the integrated photonic system 900.

For example, FIG. 9B shows one variation of an integrated photonic system 920 in which a first photonic die 922 is bonded to, laterally aligned with, and at least partially positioned in a cavity 926 defined in a second photonic die 924 (shown in cross section) using any of the techniques described herein. In these variations, the first photonic die 922 may be configured to emit light 928 vertically from a horizontal surface thereof, which may be received by a coupler 930 (e.g., a grating coupler or the like) of the second photonic die 924.

For example, FIG. 9C shows one variation of an integrated photonic system 940 in which a first photonic die 942 is bonded to, laterally aligned with, and at least partially positioned in a cavity 946 defined in a second photonic die 944 (shown in cross section) using any of the techniques described herein. In these variations, the first photonic die 922 may be configured to emit light 948 vertically from a horizontal surface thereof, which may be received by a third photonic die 950 (e.g., via a coupler 952). In still other instances, it should be appreciated that some of the techniques described herein may be used to align a pair of photonic dies that are positioned side-by-side in an integrated photonic system, such as to align the photonic dies on a common carrier.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. An integrated photonic system, comprising:
a first photonic die; and
a second photonic die defining a cavity extending at least partially therethrough, wherein:
the first photonic die extends at least partially into the cavity and is bonded to the second photonic die along a vertical direction; and
one or more vertical surfaces of first photonic die contact one or more vertical surfaces of the second photonic die to form multiple noncontiguous contact points between the first photonic die and the second photonic die, thereby laterally aligning the first photonic die and the second photonic die.

2. The integrated photonic system of claim 1, wherein:
a portion of a first side of the first photonic die is shaped to define a first cavity;
a portion of a first side of the second photonic die is shaped to define a first protrusion; and
the first photonic die is positioned such that the first protrusion is positioned at least partially inside the first cavity to contact the first side of the second photonic die.

3. The integrated photonic system of claim 2, wherein:
the first protrusion has a curved cross-sectional shape; and
the first cavity has a rectangular cross-sectional shape.

4. The integrated photonic system of claim 2, wherein:
the first protrusion has a curved cross-sectional shape; and
the first cavity has a triangular cross-sectional shape.

5. The integrated photonic system of claim 2, wherein:
the first protrusion has a curved cross-sectional shape; and
the first cavity has a curved cross-sectional shape.

6. The integrated photonic system of claim 2, wherein:
an additional portion of the first side of the photonic die is shaped to define a second cavity;
an additional portion of the first side of the second photonic die is shaped to define a second protrusion; and
the first photonic die is positioned such that the second protrusion is positioned at least partially inside the second cavity to contact the first side of the second photonic die.

7. The integrated photonic system of claim 6, wherein:
the second protrusion contacts the first side of the second photonic die at two non-contiguous points of contact.

8. The integrated photonic system of claim 1, wherein:
a portion of a first side of the first photonic die is shaped to define a first protrusion;
a portion of a first side of the second photonic die is shaped to define a first cavity; and
the first photonic die is positioned such that the first protrusion is positioned at least partially inside the first cavity to contact the first side of the first photonic die.

9. The integrated photonic system of claim 8, wherein:
an additional portion of the first side of the photonic die is shaped to define a second cavity;
an additional portion of the first side of the second photonic die is shaped to define a second protrusion; and
the first photonic die is positioned such that the second protrusion is positioned at least partially inside the second cavity to contact the first side of the second photonic die.

10. The integrated photonic system of claim 8, wherein:
the first protrusion has a curved cross-sectional shape; and
the first cavity has a rectangular cross-sectional shape.

11. The integrated photonic system of claim 8, wherein:
the first protrusion has a curved cross-sectional shape; and
the first cavity has a triangular cross-sectional shape.

12. The integrated photonic system of claim 8, wherein:
the first protrusion has a curved cross-sectional shape; and
the first cavity has a curved cross-sectional shape.

13. An integrated photonic system, comprising:
a first photonic die; and
a second photonic die defining a cavity extending at least partially therethrough, wherein:
the first photonic die extends at least partially into the cavity and is bonded to the second photonic die along a vertical direction;
a first pair of vertical engagement surfaces provides at least one noncontiguous contact point between the first photonic die and the second photonic die;
the first pair of vertical engagement surfaces are formed in a pair of adjacent sides of the first photonic die and the second photonic die;
a first side of the pair of adjacent sides is shaped to define a first protrusion;
a second side of the pair of adjacent sides is shaped to define a first cavity; and
the first protrusion extends at least partially into the first cavity to contact the second side at one or more noncontiguous contact points.

14. The integrated photonic system of claim 13, wherein:
a surface of the first cavity forms a facet for a first set of waveguides;
a surface of the first protrusion forms a facet for a second set of waveguides.

15. The integrated photonic system of claim 14, wherein:
the first protrusion has a rectangular cross-sectional shape; and
the first cavity has a rectangular cross-sectional shape.

16. The integrated photonic system of claim 14, wherein:
the first protrusion contacts the second side of a plurality of noncontiguous contact points.

17. The integrated photonic system of claim 14, wherein:
the first side of the pair of adjacent sides is shaped to define a second protrusion;
the second side of the pair of adjacent sides is shaped to define a second cavity; and
the second protrusion extends at least partially into the second cavity to contact the second side at one or more additional noncontiguous contact points.

18. An integrated photonic system, comprising:
a first photonic die; and
a second photonic die defining a cavity extending at least partially therethrough, wherein:
a wedge-shaped portion of the first photonic die extends at least partially into the cavity and is bonded to the second photonic die along a vertical direction;
the wedge-shaped portion of the first photonic die comprises a first side and a second side opposite the first side;
the first side of the wedge-shaped portion acts a facet for one or more waveguides of the first photonic die;
the second side of the wedge-shaped portion acts a facet for one or more waveguides of the first photonic die;
a first side of the second photonic die is shaped to define a first set of protrusions contacting the first side of the wedge-shaped portion; and
a second side of the second photonic die is shaped to define a second set of protrusions contacting the second side of the wedge-shaped portion.

19. The integrated photonic system of claim 18, wherein:
each of the first set of protrusions acts a facet for one or more waveguides of the second photonic die.

20. The integrated photonic system of claim 19, wherein:
each of the second set of protrusions acts a facet for one or more waveguides of the second photonic die.
